(19) United States
(12) Patent Application Publication
(10) Pub. No.: US 2006/0229921 A1
(43) Pub. Date: Oct. 12, 2006

(54) Business Control System

(75) Inventor: Patrick John Colbeck, Canton, MI (US)

Correspondence Address: PATRICK JOHN COLBECK, 47841 ROYAL POINTE DRIVE, CANTON, MI, 48187-5464, US

(73) Assignee: Mr. Patrick John Colbeck, Canton, MI (US)

(21) Appl. No.: 10/907,643

(22) Filed: Apr. 8, 2005

(51) Int. Cl. G06F 17/50

(52) U.S. Cl. 705/7

(57) ABSTRACT

The Business Control System (BCS) is a management method designed to facilitate the control of complex business operations. The method combines project management principles with control system engineering modeling, analysis and design techniques within a robust information technology framework. The BCS provides managers with the ability to design their business operations to meet specific financial performance objectives. Once a business has been modeled, managers have the ability to automate the management of different segments of the business operations. The BCS provides a tangible mechanism for connecting specific business activities to line items in standard classes of financial reports such as Balance Sheets or Income Statements.

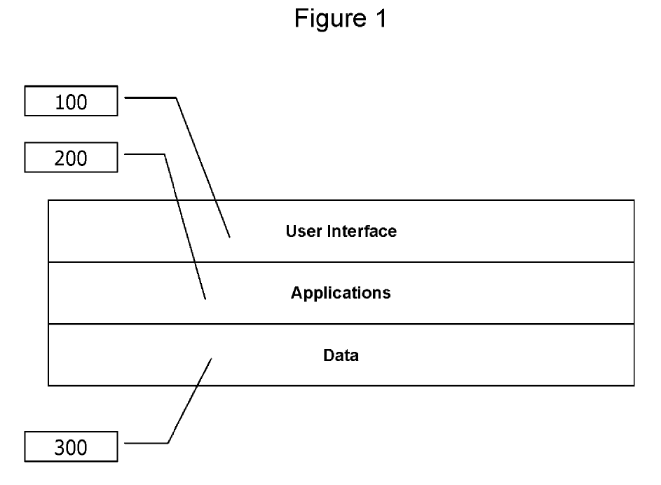

The Business Control System is any Management Information System that conforms to the Logical Architecture defined in FIG. 1 and manages business information in accordance with the methods defined herein.

The logical architecture provides the minimum system specifications for any Physical Architecture intended to implement the BCS. The logical architecture consists of three main layers—User Interface, Application, and Data.

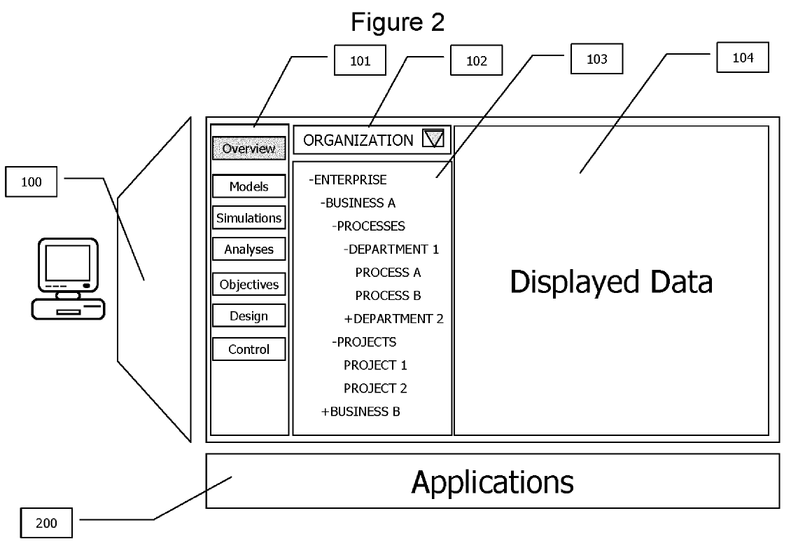

The User Interface Layer portrayed in FIG. 2 uses web browser-friendly file protocols such as html, xml, java, and asp scripts to execute functionality contained in the Application Layer. The User Interface consists of four main sections.

Section 101 is the Module Frame section. The Module Frame section provides users with access to functionality specific to each high-level step within the BCS business method.

Section 102 is the Hierarchy Selection section. The Hierarchy Selection section provides users with the ability to select the tree structure by which they would prefer to view BCS data. This capability would allow users to see data organized by a variety of tree structures including an organization chart, product lines, value streams, region, resource category or chart of accounts.

Section 103 is the Navigation Tree section. The Navigation Tree section provides users with the ability to select a specific branch of interest within a given tree structure. This capability would provide users to drill down into low-level business information or high-level rollups of this information.

Section 104 is the Displayed Data section. The Displayed Data section displays data and functions specific to the active module and navigation tree selection.

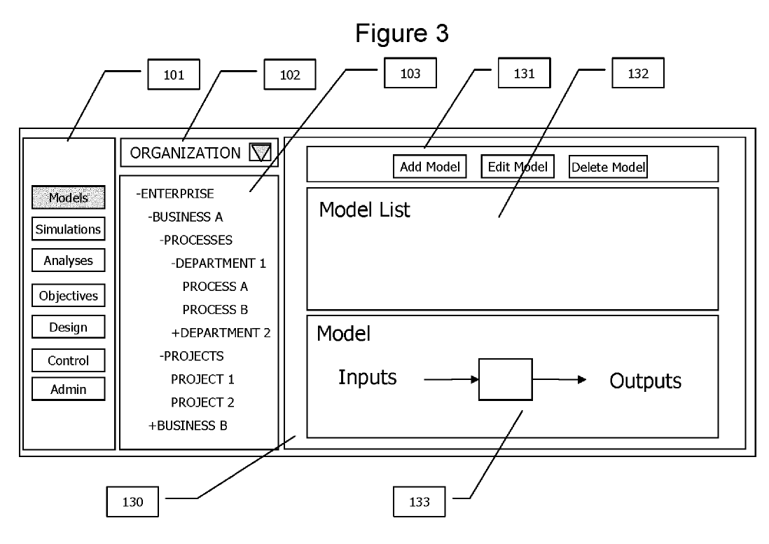

The Models User Interface provides users with the ability to manage the mathematical models in the system or subset thereof. The key features of the Model User Interface Layer are defined in FIG. 3.

Item 130 depicts the sample content for Section 104 when the “Models” module is active. The key features of this section are model management capabilities such as adding/editing/deleting models, a list of models, and a model attributes overview for selected model.

Item 131 provides users with access to model management capabilities such as adding, deleting or editing models. Users wishing to add a new model will be presented with the ability to start from scratch or from an existing model in the model library.

Item 132 provides users with a list of models associated with the active branch of the current tree structure.

Item 133 provides users with an overview of the model selected from the model list. The user is provided with a list of inputs, list of outputs and a symbolic representation of the model transfer function.

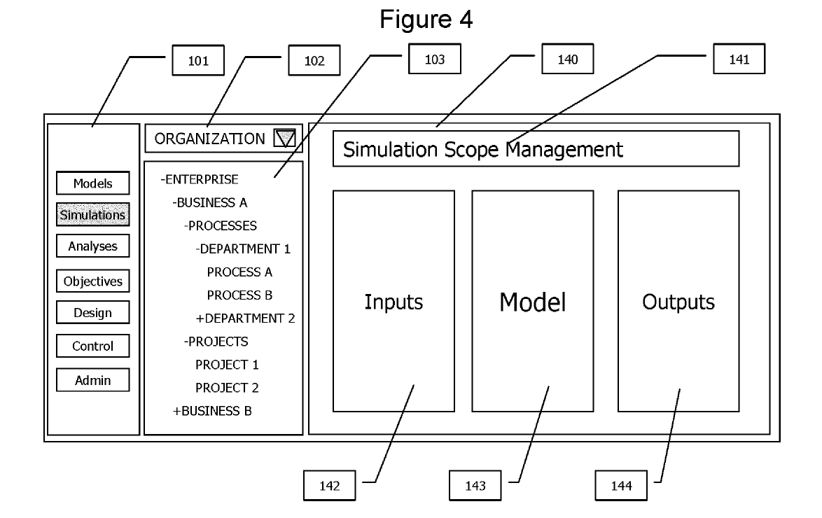

The Simulation User Interface Layer provides users with the ability to simulate the mathematical models for the entire system or subset thereof. The key features of the Simulation User Interface Layer are defined in FIG. 4.

Item 140 depicts the sample content for Section 104 when the “Simulation” module is active. The key features of this section are input management, output management and transfer function parameter management.

Item 141 provides users with the ability to run a simulation of the active model in isolation from the other models in the system or in conjunction with the other models in the system or subset thereof.

Item 142 provides users with the ability manage and monitor the values of model input parameters. Users will have the capability to specify initial conditions for any parameters that are not being driven by other models in the system. Input profiles can take the form of constants, step inputs, ramp inputs, or complex formulae. Actual values of the input parameters can also be monitored as the user steps through the simulation.

Item 143 provides users with the ability to manage and monitor the value of model transfer function parameters. Users are provided with the capability to adjust the value of transfer function parameters and save these values as desired.

Item 144 provides users with the ability to manage and monitor the values of model output parameters. Users will have the capability to monitor the actual values of the output parameters. Once performance objectives have been established for a given model, the user will also be able to track output parameter performance against those objectives.

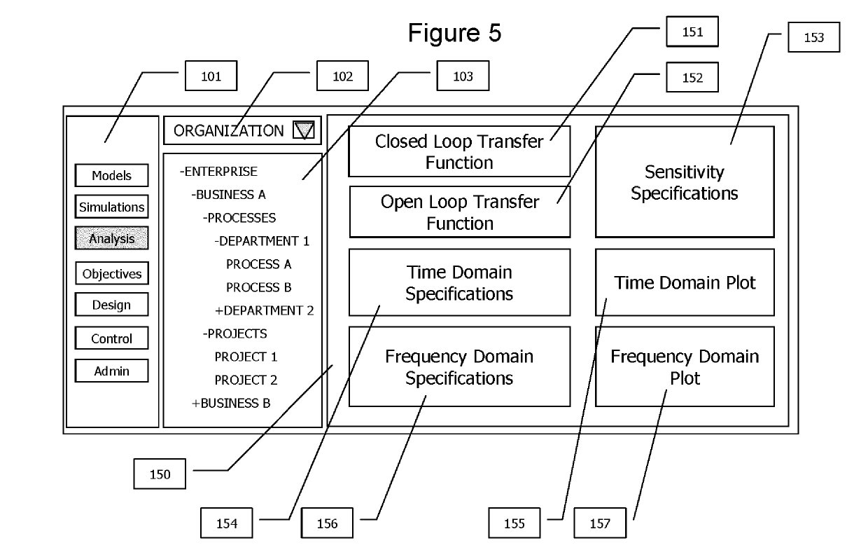

The Analysis User Interface Layer provides users with the ability to analyze the mathematical models defined in the system or subset thereof. The key features of the Analysis User Interface Layer are defined in FIG. 5.

Item 150 depicts the sample content for Section 104 when the “Analysis” module is active. The key features of this section are model overview, sensitivity specifications, model time domain specifications, model frequency domain specifications, plot of open-loop transfer function in time domain, and a plot of the open-loop transfer function in the frequency domain.

Item 151 provides users with a symbolic display of the active model closed loop transfer function attributes in the same manner as in Item 133.

Item 152 provides users with a symbolic display of the active model open loop transfer function attributes in the same manner as in Item 133.

Item 153 provides users with a summary of the model's sensitivity to specific system parameters. A ranked list of system parameters is grouped by output parameter and presented with a normalized influence factor for each system parameter.

Item 154 provides users with a summary of the model's time domain specifications. The time domain performance specifications for each output parameter are tabulated for user reference. Time domain performance specifications include steady-state error and the following values in response to a unit step input: overshoot, delay time, rise time, settling time, and predominant time constant.

Item 155 provides users with a plot of the closed-loop poles and zeroes of the model transfer function in the time domain.

Item 156 provides users with a summary of the model's frequency domain specifications. The frequency domain performance specifications for each output parameter are tabulated for user reference. Frequency domain performance specifications include the following values: gain margin, phase margin, delay time, bandwidth, cutoff rate, resonance peak, and resonant frequency.

Item 157 provides users with a plot of the open-loop transfer function's magnitude and phase performance in the frequency domain.

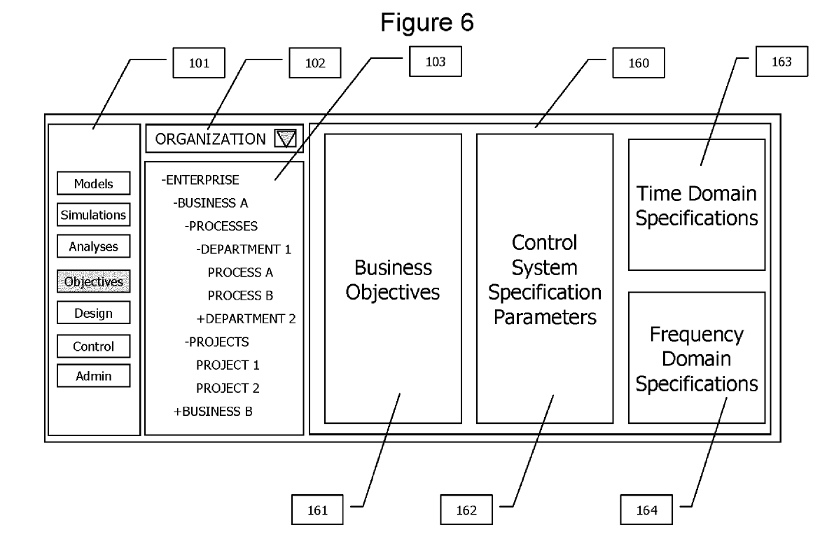

The Objectives User Interface Layer provides users with the ability to define performance objectives for the business or subset thereof. The key features of the Objectives User Interface Layer are defined in FIG. 6.

Item 160 depicts the sample content for Section 104 when the “Objectives” module is active. The key features of this section are business objectives management, control system specification mapping, system time domain specification requirements management and system frequency domain specification requirements management.

Item 161 provides users with the ability to select from a standard list of business objectives and specify the desired value for the active model branch. The business objectives are presented in standard business terms such as increase profit margin, decrease expenses, or even increase market share.

Item 162 provides users with the ability to identify which control system specification parameters are most applicable to a given business objective.

Item 163 provides users with a summary of the system time domain specification values that would be necessary for the user to achieve the business objectives defined in Item 161.

Item 164 provides users with a summary of the system frequency domain specification values that would be necessary for the user to achieve the business objectives defined in Item 161.

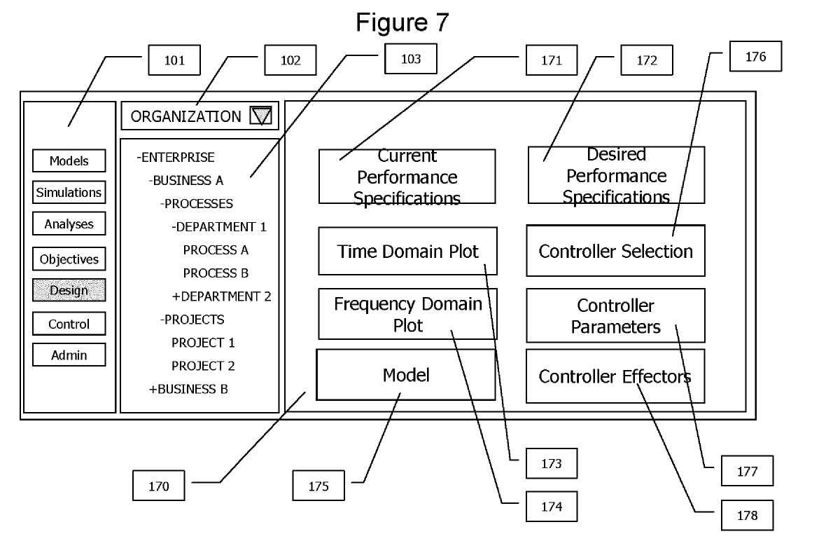

The Design User Interface Layer provides users with the ability to design mathematical control models to meet the performance objectives for the business or subset thereof. The key features of the Design User Interface Layer are defined in FIG. 7.

Item 170 depicts the sample content for Section 104 when the “Design” module is active. The key features of this section are current performance specifications, desired performance expectations, a plot of open-loop transfer function in time domain, a plot of the open-loop transfer function in the frequency domain, a model overview, controller selection, controller parameters, and controller effectors.

Item 171 includes a summary of the current system specifications as determined during the Analysis Stage.

Item 172 includes a summary of the desired system performance specifications as determined during the Set Objectives Stage.

Item 173 provides users with a plot of the poles and zeroes of the model transfer function in the time domain.

Item 174 provides users with plots of the transfer function's magnitude and phase performance in the frequency domain.

Item 175 provides users with a graphical representation of the combined plant and control model for the active branch of the navigation tree. This representation includes a listing of model inputs and outputs.

Item 176 provides users with a menu of standard controller types from which to choose including proportional, integrative, derivative or combinations thereof.

Item 177 provides users with the ability to specify the values of controller parameters and connect the control model with the applicable input data sources.

Item 178 provides users with the ability to select the appropriate effectors associated with the control signal such as email templates.

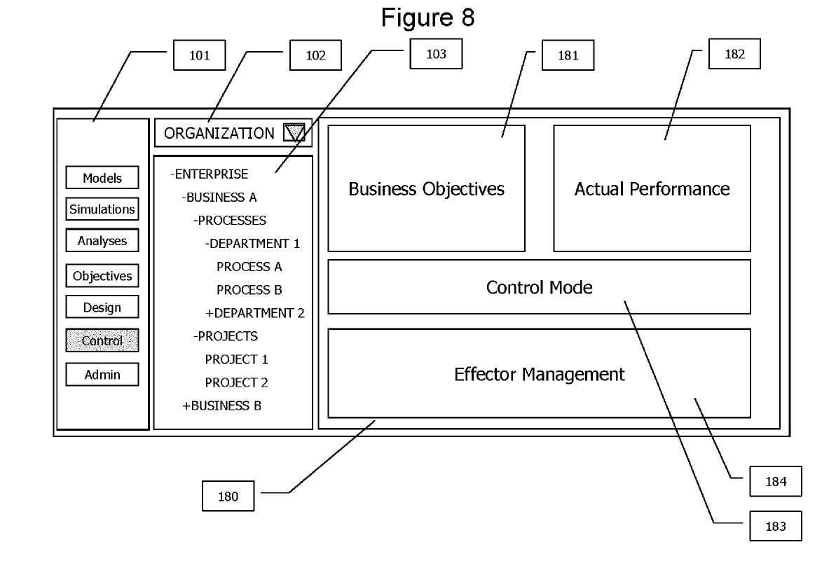

The Control User Interface Layer provides users with a control panel interface for the business or subset thereof. From this control panel, users will have the ability to execute the control models defined in the system in an automatic, semi-automatic or manual manner. The key features of the Control User Interface Layer are defined in FIG. 8.

Item 180 depicts the sample content for Section 104 when the “Control” module is active. The key features of this section are business objectives review, system performance monitoring, mode management, and effector management.

Item 181 provides users with the ability to display the business objective and associated values for the active tree structure branch.

Item 182 provides users with the ability to display the actual system performance values corresponding to the business objectives displayed in Item 181.

Item 183 provides users with the ability select the control mode applicable to the active branch of the tree structure. Users have the ability to select “Automatic”, “Semi-Automatic” or “Manual” modes of operation.

Item 184 provides users with the ability to manage the execution of system “effectors”. If the control mode is “manual”, the user would be able to enter an effector command to act as a control signal. If the control mode is “semi-automatic”, the user may be able to activate a specific effector depending upon the parameter value and the pertinent security permissions.

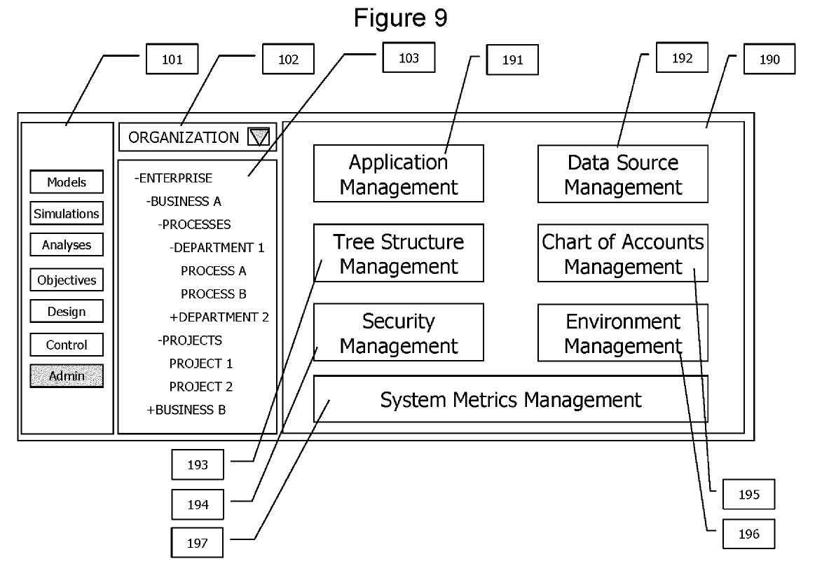

The Administration User Interface Layer provides administrators with the ability to manage the overall system configuration. The key features of the Administration Interface Layer are defined in FIG. 9.

Item 190 depicts the sample content for Section 104 when the “Administration” module is active. The key features of this section are security management, application management, data source management, system metrics management, tree structure management, and environment management.

Item 191 provides administrators with the ability to manage the system application portfolio. Administrators would be able to manage the versions of applications associated with a given system module and ensure that there are sufficient licenses to support the user community for a given application.

Item 192 provides administrators with the ability to manage the sources of data that drive the system. Administrators are provided with functions that allow them to associate a given parameter in the active model for a given branch of the tree structure to a specific data source.

Item 193 provides administrators with the ability to manage system tree structures. Administrators are able to add, delete, or edit existing tree structures and their associations with models.

Item 194 provides administrators with the ability to manage field-level security permissions for users and groups thereof.

Item 195 provides administrators with the ability to manage the chart of accounts.

Item 196 provides administrators with the ability to manage multiple instances of the system environment. Administrators are able to migrate models and data from one environment to another environment. This capability enables businesses to simulate business control models or subsets thereof prior to rolling them to production. It also provides administrators with the ability to add business models from other organizations or split up existing business models for migration to another organization.

Item 197 provides administrators with the ability to monitor and manage system deployment metrics such as the number of models, percentage of controllers operating in automatic mode, etc.

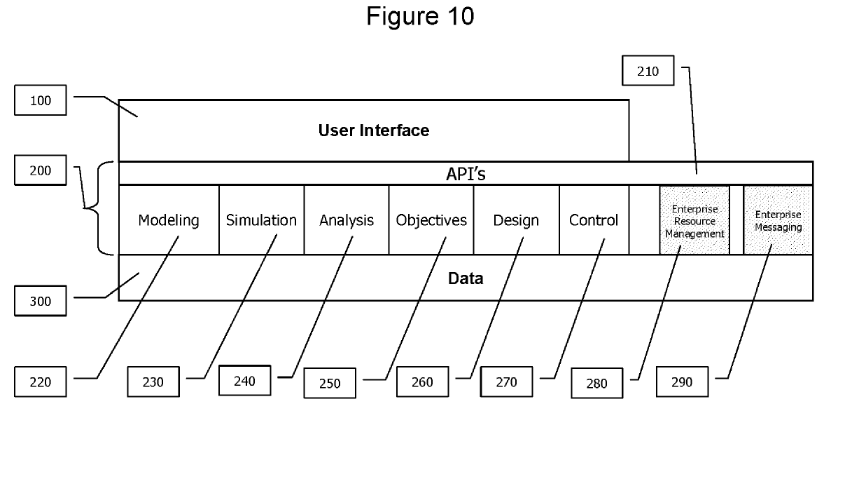

The Application Layer defined in FIG. 10 uses one or more software applications or embedded hardware controllers to execute the BCS methods. Each of the applications can be executed from the applicable section of the user interface layer and has access to the pertinent segment of the data layer.

Item 210 pertains to Application Program Interfaces (API's). API's are provided to enable applications in the application layer to execute functions contained in other applications. The need for API's in a given system configuration is a function of the physical architecture.

Item 220 pertains to the Model Engine. The Model Engine provides users with the ability to formulate plant and control models. The engine provides the ability to define transfer functions for models. These transfer functions are parametric models based upon mathematical expressions and logical arguments. The inputs and outputs for the model are treated as variables that can be connected to other models as inputs or outputs. The engine generates the model data in a format that can be accessed by other applications.

Item 230 pertains to the Simulation Engine. The Simulation Engine provides discrete time simulation capabilities for the business system. The engine allows users to step the models through time and predict the business system performance for a given model or set thereof. The engine generates the simulation data in a format that can be accessed by other applications.

Item 240 pertains to the Analysis Engine. The Analysis Engine provides the ability to determine the time domain and frequency domain specifications for a model or set thereof. The engine generates the analysis data in a format that can be accessed by other applications.

Item 250 pertains to the Objectives Engine. The Objectives Engine is a data association tool that provides the ability to map business performance objectives to system performance specifications for models or sets thereof. These specifications will be accessed by controllers as set points in the execution of the pertinent control model. The objectives engine generates the objectives data in a format that can be accessed by other applications.

Item 260 pertains to the Design Engine. The Design Engine provides the ability to design control models that meet specific performance objectives for a given model or set thereof. The engine provides a variety of tools to help users identify the appropriate controller type and parametric values for the control model. These tools include the use of time domain and frequency domain plots and step-by-step point design tutorials. The controllers are linked to effectors ranging from direct command inputs for embedded controllers to email messages directing resources to take a given course of action. Message-based control signals can take several forms including those of project approvals, activity prioritization, or resource allocations. The engine genearates all design data in a format that can be accessed by other applications.

Item 270 pertains to the Control Engine. The Control Engine provides users with the ability to control the execution of the control models that have been defined. The engine can be executed in one of three modes—automated, semi-automated or manual. Automated control models will be executed without user input. Semi-automated control models may execute one or more of the control signals without user intervention, but at least one of the signals require user intervention. Manual control models will not execute without user intervention. The engine generates all control data in a format that can be accessed by other applications.

Item 280 pertains to Enterprise Resource Management applications. The BCS is designed to take advantage of data provided by existing Enterprise Resource Management Applications such as Enterprise Resource Planning (ERP), Enterprise Project Management (EPM), or Accounting. BCS Applications can be designed to execute functions within the existing Enterprise Resource Management Applications or simply leverage the information generated by those applications to provide data to BCS controllers.

Item 290 pertains to Enterprise Messaging applications. The BCS is designed to take advantage of existing Enterprise Messaging Systems such as Workflow Management Systems, Email Systems or Web-Based Team Sites to provide direction to resources and even applications in response to control signals. The BCS leverages forms within Enterprise Messaging systems to distribute messages with content tailored to reflect the control effort (e.g. hire a number of resources with a specific skill type) necessary to meet the performance specifications.

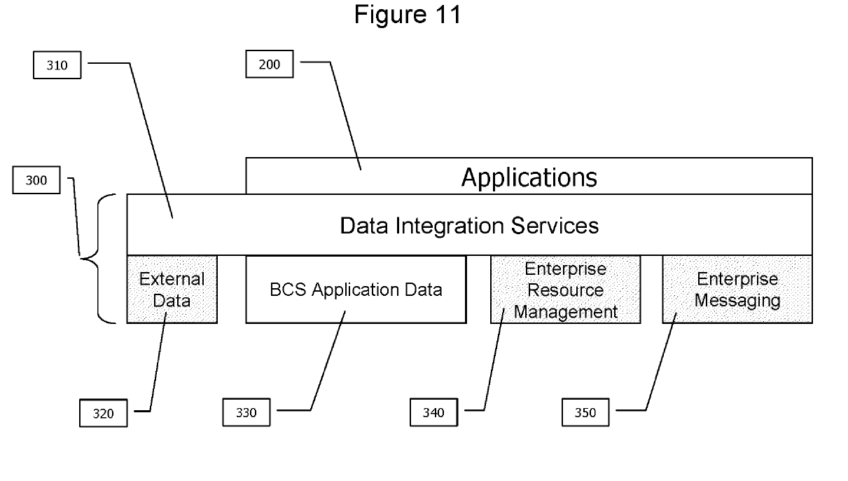

The Data Layer defined in FIG. 11 is where the data that drives the BCS resides. The Data Layer consists of five principle sections—Data Integration Services, External Data Sources, BCS Application Data, Enterprise Resource Management Data, and Enterprise Messaging Data.

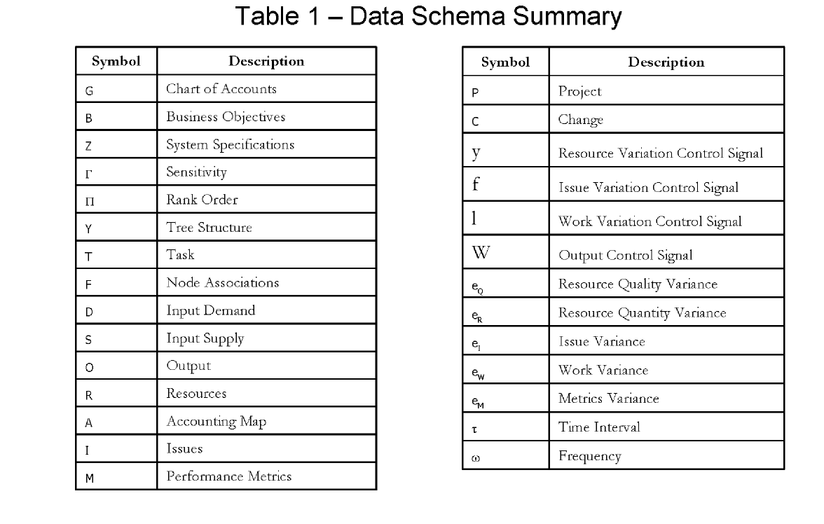

Section 310 corresponds to Data Integration Services. The data required to operate the BCS may come from more than one source and each data source may store information in a unique format. In order for the Application Layer components to work effectively, all of the information needs to be accessible in a format that is compatible with the needs of the Application Layer. The Data Integration Services layer is responsible for the mapping of data from multiple sources into a single data schema compatible with the Application Layer. This data schema is summarized in FIG. 50.

Section 320 corresponds to External Data sources. External data sources contain data for which the responsibility for generation and quality of the data is outside of the organization scope of the business of concern. Applications will access the data in external databases by either accessing an internal database configured to mirror the content of an external database, extracting tagged data directly from an internet site hosting the data, or via trusted network connections to the external data store.

Section 330 corresponds to BCS Application Data. BCS Application Data is stored in a format optimized for access by BCS applications. This data is stored in one or more databases depending upon the size of the system and system performance specifications. Applications will access the data via a trusted network connection or direct installation of the application(s) on the platform hosting the database.

Section 340 corresponds to Enterprise Resource Management Data. Enterprise Resource Management Data is stored in a format optimized for access by the pertinent Enterprise Resource Management system. The Data Integration Services are responsible for converting the data into a format that can be used by the BCS Applications. This data can then be stored in BCS Application Data stores or converted on demand depending upon the performance requirements for the system. Applications will access the data via a trusted network connection or direct installation of the application(s) on the platform hosting the data source.

Section 350 corresponds to Enterprise Messaging Data. Enterprise Messaging Data is stored in a format optimized for access by the pertinent Enterprise Messaging System. Enterprise Messaging data consists of forms and templates created in the pertinent Enterprise Messaging System application to support the BCS. The forms and templates must be configured to access information from the BCS Application Data stores or directly from BCS Applications. The forms and templates will be populated with parametric values from the BCS Applications. Applications will access the data via a trusted network connection or direct installation of the application(s) on the platform hosting the data source.

The Physical Architecture refers to any configuration of software and hardware products to create one or more instances of the Logical Architecture. Multiple instances of the Logical Architecture can be used to keep analysis and design environments separate from the active production environment.

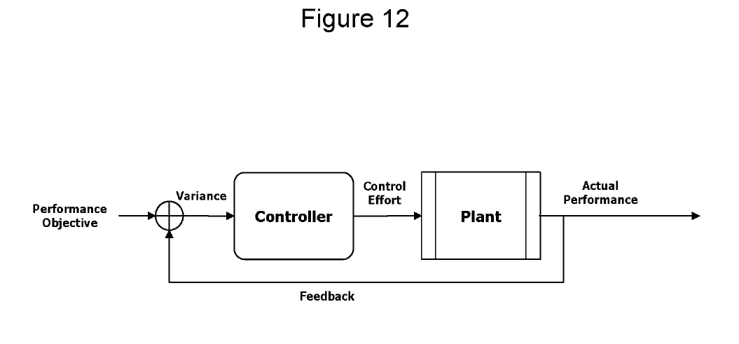

The fundamental framework for the Business Control System is a simple feedback control system as depicted in FIG. 12. This basic concept is replicated in a variety of model “classes” tailored to support the BCS business method. The core model classes for the BCS are Task Models, Resource Models, Process Models, Project Models, and Business Models. Each of these model classes features inputs, outputs and some sort of transfer function that converts the input values into a set of output values. The differences between these models are the specific inputs and outputs required by each class of model. These inputs and outputs are used to connect the individual models together to form systems of models. The ability to form systems of models provides users with a robust tool to model various resolutions of business operations. This inherent robustness enables BCS users to control all resource-based activities for a single task or an entire enterprise. In order to provide this flexibility, it is important that all of these models leverage a common data schema.

The BCS Data Schema is summarized in FIG. 50. This data schema defines the minimum information types necessary to implement a Business Control System. In accordance with Item 300 in FIG. 11, this data may come from a variety of sources but at least one set of data sources must enable read/writer operations as a result of procedures executed by Applications defined in Item 200 of FIG. 10.

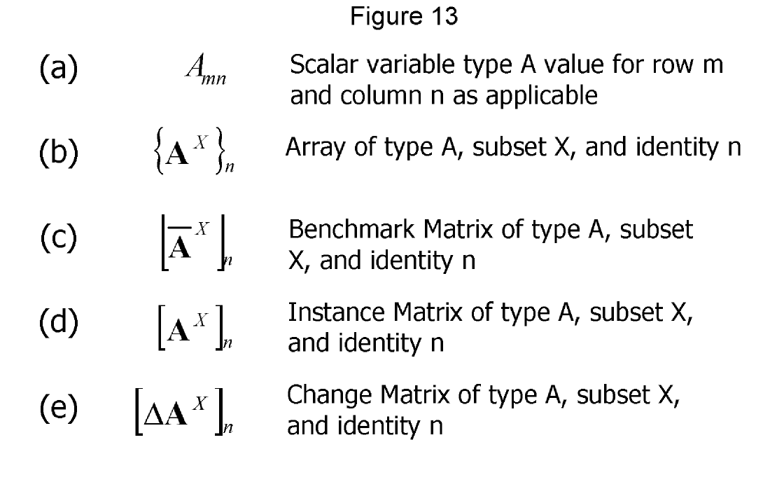

The standard convention for data notation is depicted in FIG. 13. Each information type may have one or more instances of each notation referenced in the BCS models. For the sake of simplicity, only the default instance matrix for each information type is typically referenced in this section rather than all notation permutations referenced in the BCS models.

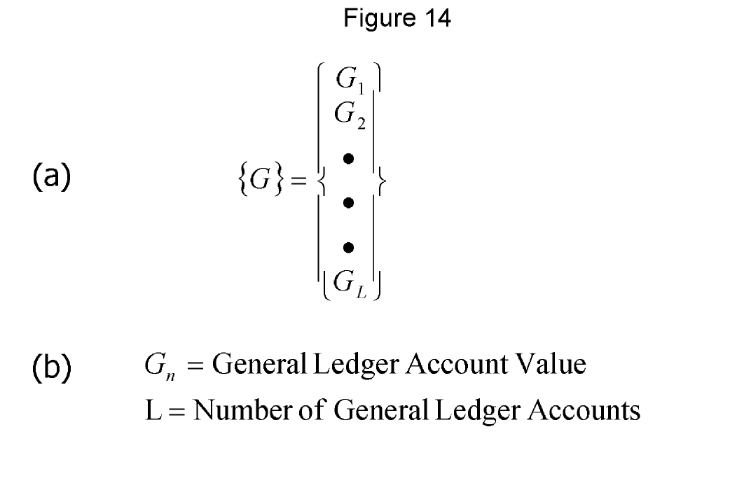

The General Ledger data schema is depicted in FIG. 14. The General Ledger Matrix reflects the chart of accounts for the organization and provides a mechanism for tracking revenue, expenses, assets, and liabilities. Chart of account values are calculated on the basis of resource consumption and supply. These values are used to convert business objectives into system specifications that can be used to design control models.

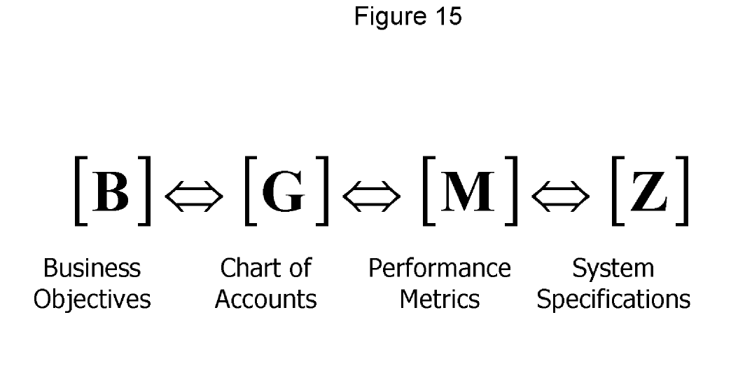

The Metrics data schema is captured in four sets of matrices—Business Objectives, Chart of Accounts, Performance Metrics, and System Specifications. The relationship between these data sets is depicted in FIG. 15. The BCS also captures task sensitivity factors and generates a rank order matrix of tasks based upon this sensitivity information.

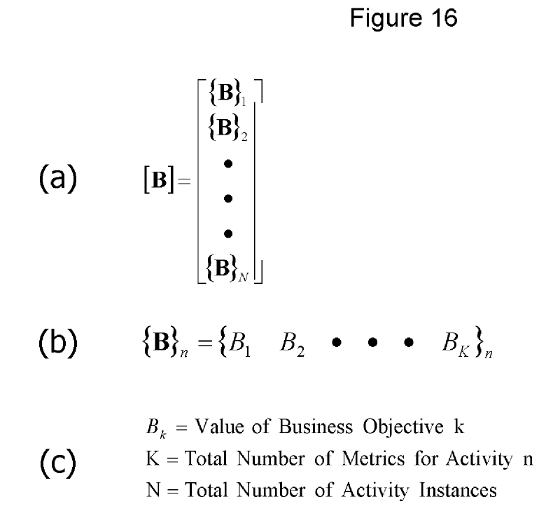

Business Objectives capture system performance objectives in terms that are recognizable to most managers. The Business Objectives matrix is depicted in FIG. 16. This matrix is defined by users and used to specify the values of the performance specifications.

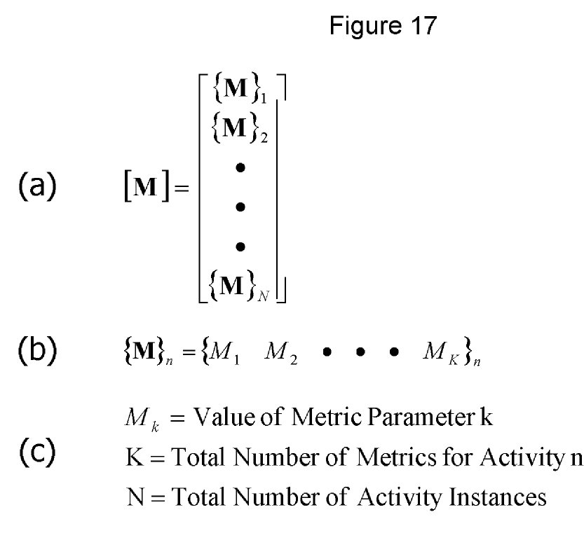

Metrics matrices capture system performance objectives in terms that are suitable for use as setpoints for controllers. A generic Metrics matrix is depicted in FIG. 17. Metrics matrices capture meta data for process and project models.

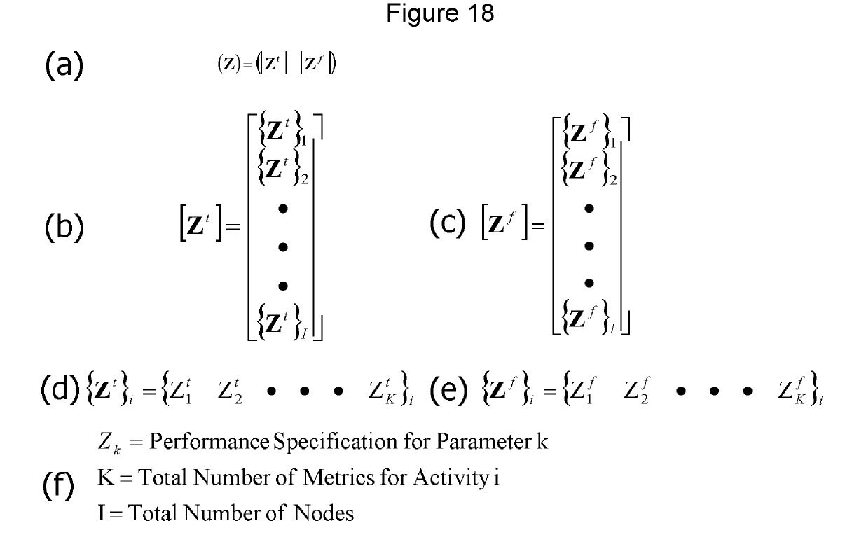

Control System Specifications capture system performance values in terms that are suitable for control system analysis, design, and control. Control Systems Specifications are depicted in FIG. 18. Time Domain and Frequency Domain performance specifications can be calculated for each instance of a given model class.

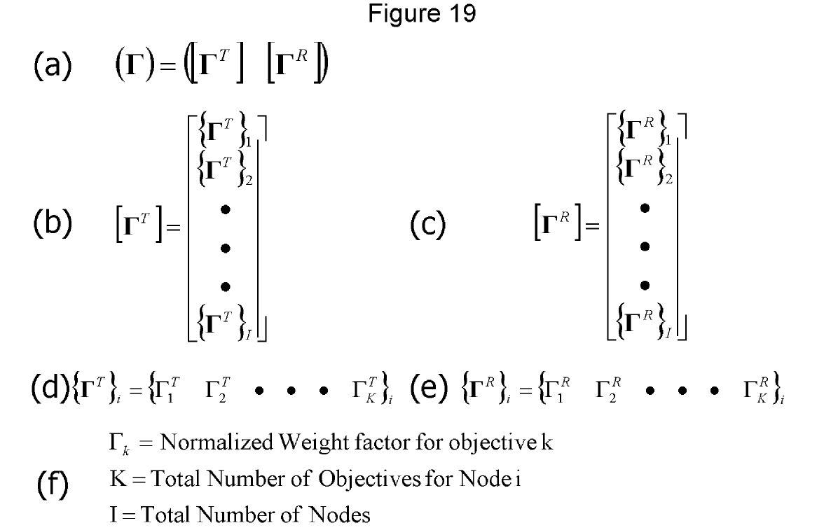

The Task Sensitivity Matrix captures the relative influence of different tasks on a given set of business objectives. The Task Sensitivity Matrix is depicted in FIG. 19. Task Sensitivity factors are calculated for all task instances against each business objective.

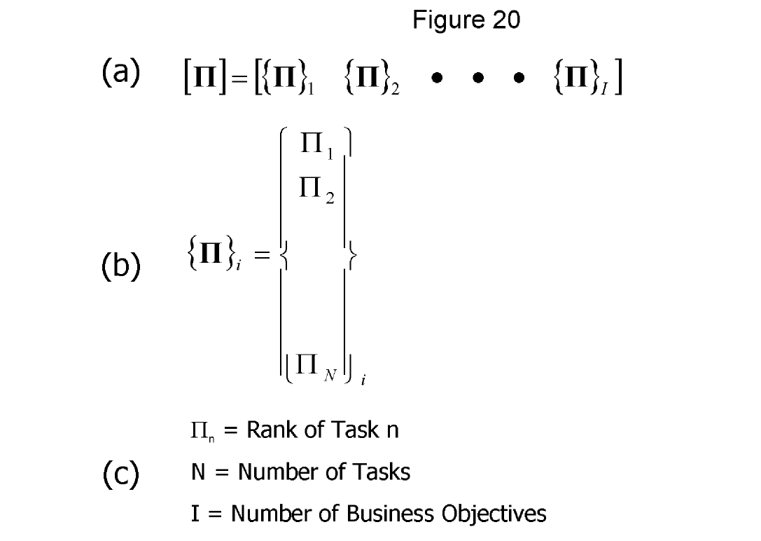

The Task Rank Matrix is simply a rank order listing of task id's based upon their influence on a given business objective. The Task Rank Matrix is depicted in FIG. 20. The Task Rank Matrix is tabulated for each business objective for use by one or more resource controllers.

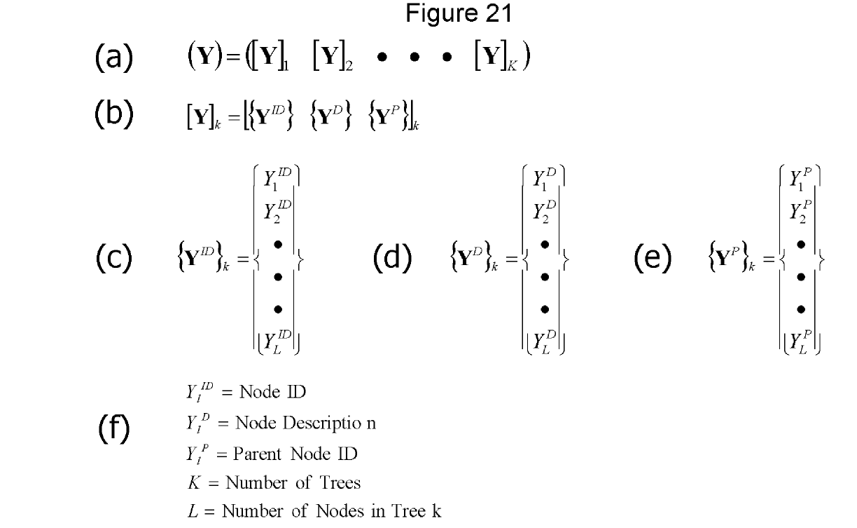

Tree structures are hierarchal schemas used to navigate the collection of models. Tree structures enable users to select the resolution of the business that they would like to model, simulate, analyze, set objectives for, design, or control. The tree structure matrix is depicted in FIG. 21. Typical tree structures that might be implemented would be an organization tree or value stream tree. Except where noted otherwise, the BCS data schema's and methods assume a single tree structure most often referred to as the default tree structure. These references should not be construed as precluding the application of this method for an environment with multiple tree structures.

Task data is captured in a set of four data sets—Task Meta Data, Input Demand Data, Input Supply Data and Output Data. Note that the variable n corresponds to the task number while N corresponds to the total number of tasks.

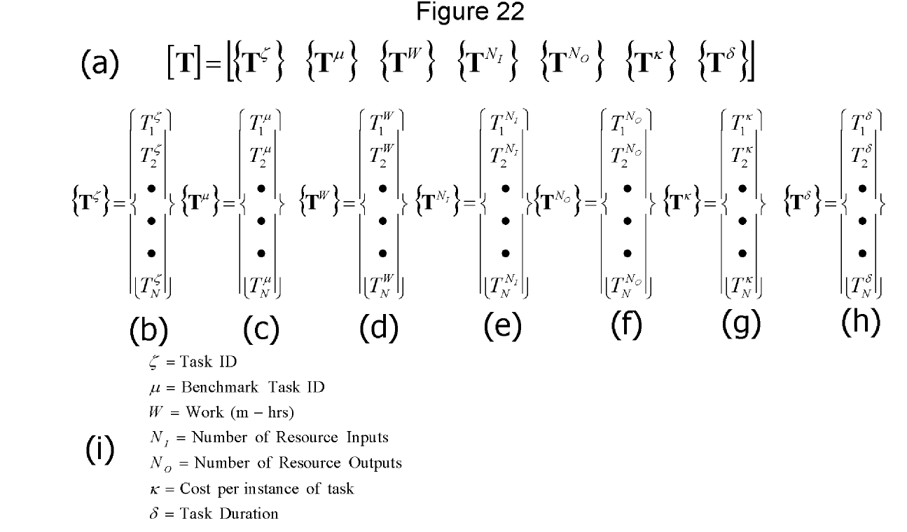

The task meta data schema is depicted in FIG. 22. Key that is captured for each task includes the following: Task ID, Benchmark Task ID, Work, Number of Resource Inputs, Number of Resource Outputs, Cost per Instance of Task, and Task Duration. The Benchmark Task ID enables access to the benchmark values for task work and duration. The actual values are tracked for each instance as the task model is stepped through time.

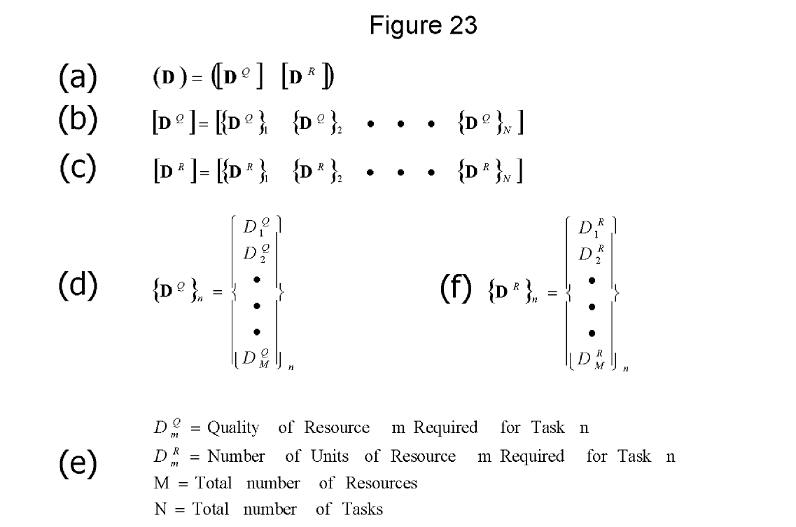

All task inputs are tracked in context of resources whether that resource be a machine, person, or report. The task input demand data schema is depicted in FIG. 23. The quality and quantity of each resource required by each task is tracked as Input Demand Data.

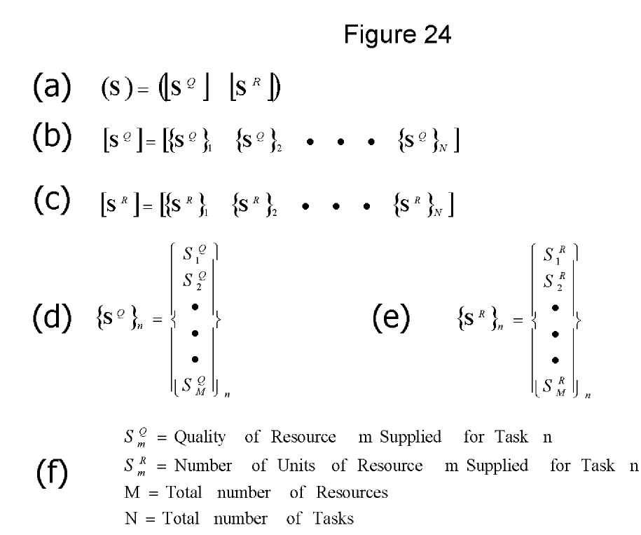

The task input supply data schema is depicted in FIG. 24. The quality and quantity of each resource supplied to each task is tracked as Input Supply Data.

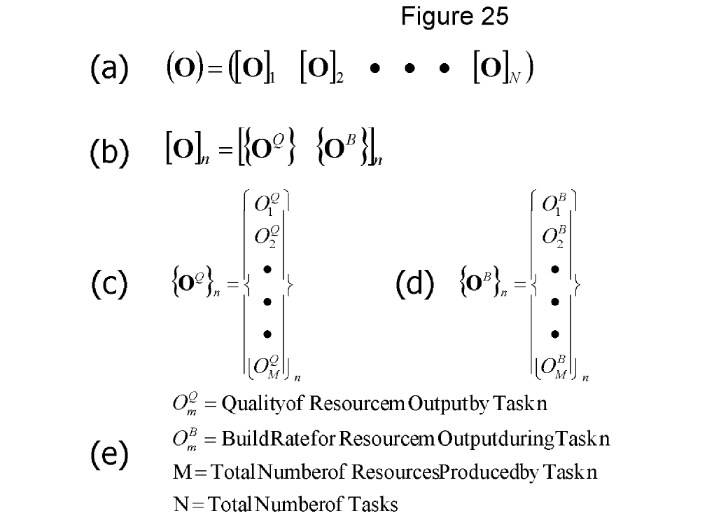

The task output data schema is depicted in FIG. 25. The task output matrix captures the production parameters around the intrinsic outputs of a given task such as build rate and quality of these outputs.

Resource data is captured in a set of two data sets—Resource Matrix and Accounting Matrix. Note that the variable m corresponds to the resource number while M corresponds to the total number of resources.

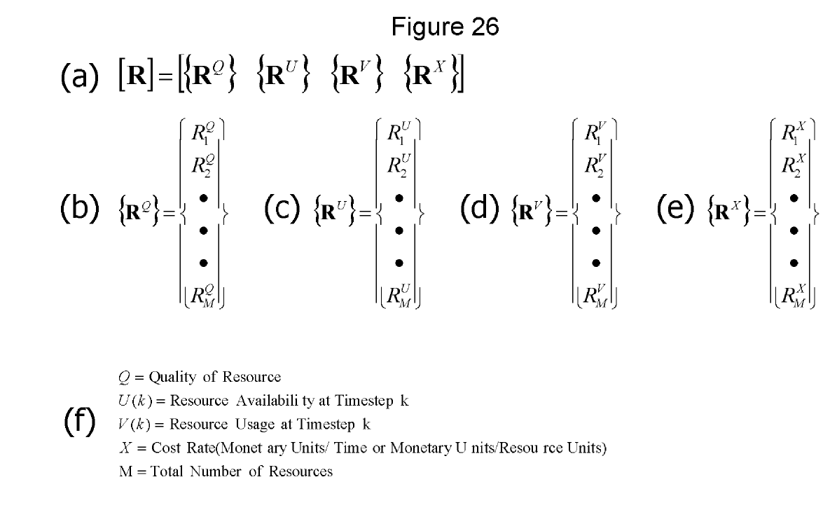

All inputs and outputs in the BCS are modeled as resources. As a result, each of these inputs and outputs is associated with a single resource instance in an enterprise-wide resource matrix. The resource matrix data schema is depicted in FIG. 26. Key information that is stored in the Resource Matrix includes resource quality, availability, usage, costs, and units. The resource matrix construct is robust enough to capture data for individual employees, manufacturing commodities or even reports.

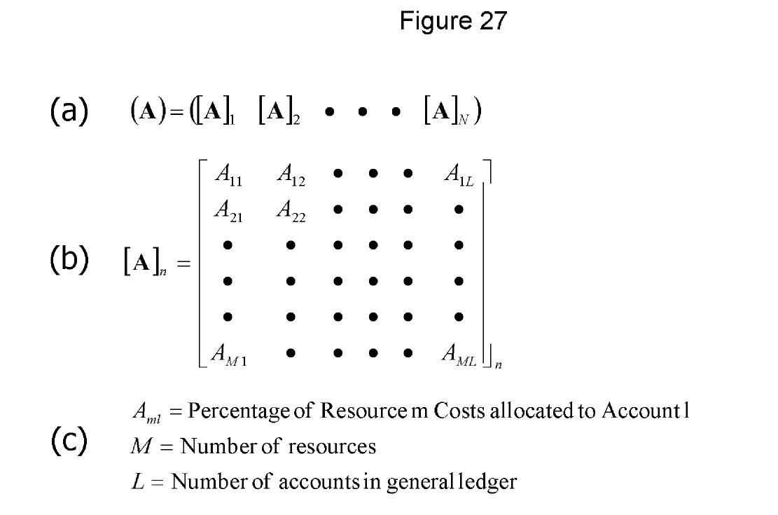

The accounting matrix data schema is depicted in FIG. 27. The accounting matrix is used to map resource usage or fraction thereof on a given task to a given account in the General Ledger.

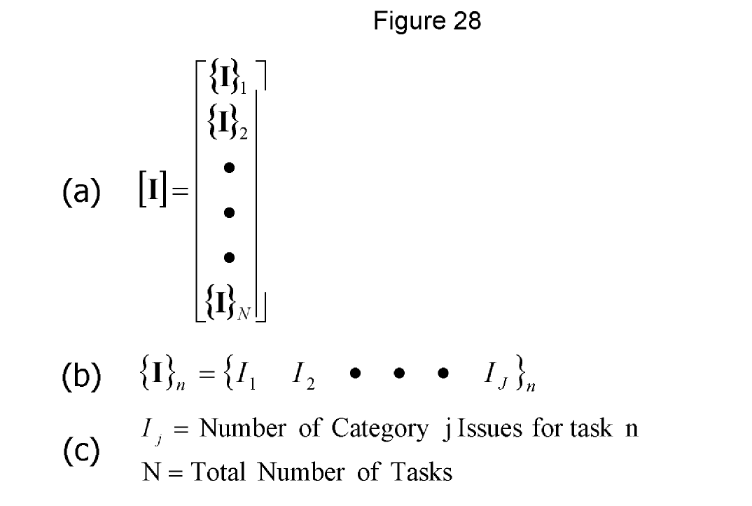

The Issue profile is tracked for each task or class of tasks. The issue data schema is depicted in FIG. 28. A typical instance of this profile would feature three categories such as high, medium, and low. The number of active issues for each of these categories against the benchmark values will help task controllers determine how much incremental work will be necessary to complete the task within benchmark quality specifications.

Processes are represented by a Metrics Matrix generated as a rollup of data from the tasks that make up the process. Process meta data is summarized in the Metrics Matrix depicted in FIG. 17.

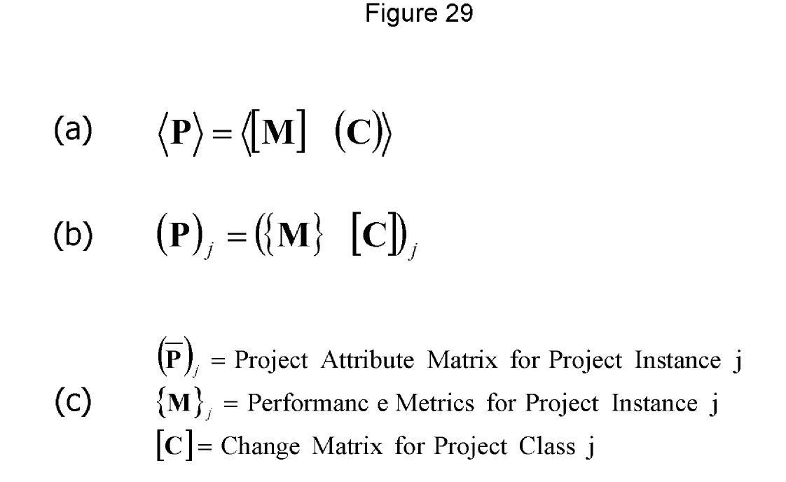

Projects are represented by a combination of a Metrics Matrix and a Change Matrix as Depicted in FIG. 29. Projects are modeled as sets of tasks in much the same manner as processes and therefore the data captured is very similar. The Change Matrix represents the unique quality of projects to change the current state of business operations.

Project data is simply the rollup of data from the tasks that drive the project. Project meta data is summarized in the Metrics Matrix depicted in FIG. 17.

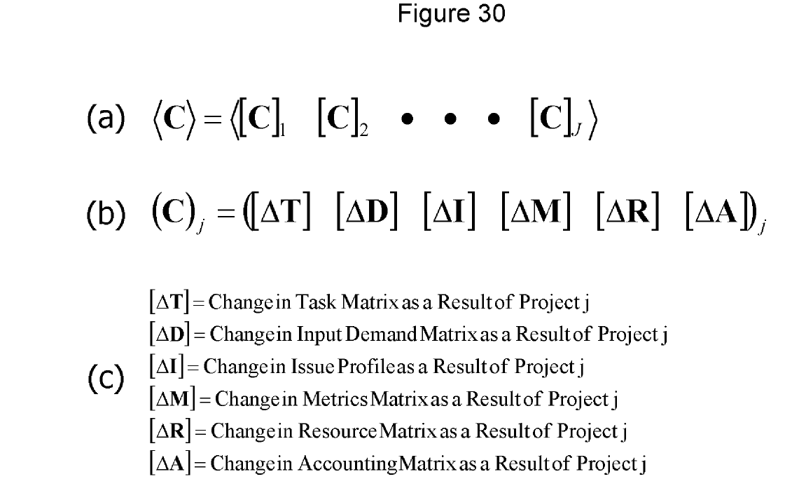

The Change Matrix captures the changes to the benchmark data for task meta data, task input demand and task issues. The Change Matrix is depicted in FIG. 30.

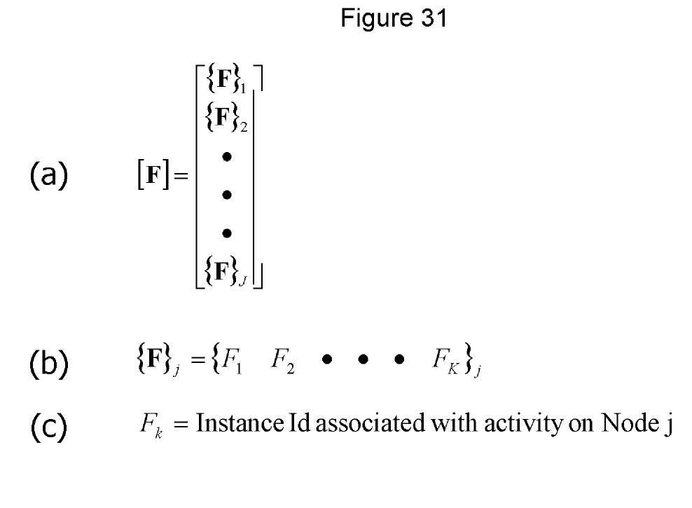

Business data is simply the rollup of data from the tasks that drive the business model. Business meta data is captured in the Metrics Matrix depicted in FIG. 17 in much the same manner as for processes and projects. The Node Association Matrix in FIG. 31 is used to associate nodes in the tree structures to a specific set of activities. The concept of a business model instance is shaped by the activities associated with a given node of a given tree structure. This flexibility allows “Business” data to be associated with many different organizational constructs including functional organizations or sets thereof.

Enterprise data refers to external data necessary to drive the control models for processes, projects or businesses. There are three basic classes of enterprise data-supplier data, customer data, and market data.

Supplier data includes standard supplier instances of standard data schema's.

The Supplier Demand data that is required is tracked as a subset of the overall Input Demand Matrix depicted in FIG. 23.

The Supplier Supply data that is required is tracked as a subset of the overall Input Supply Matrix depicted in FIG. 24.

The Supplier Resource data that is required is tracked as a subset of the overall Resource Matrix depicted in FIG. 26.

Customer data includes standard customer instances of standard data schema's.

The Customer Demand data that is required tracked as a subset of the overall Input Demand Matrix depicted in FIG. 23.

The Customer Supply data that is supplied is tracked as a subset of the overall Input Supply Matrix depicted in FIG. 24.

The Customer Resource data that is required is tracked as a subset of the overall Resource Matrix depicted in FIG. 26.

Market data includes the supply of Financial Data and Financial Performance data to external parties as well as the receipt of Economic Data.

The Financial Data that would be supplied to external organizations such as financial analysis firms and banks is tracked as a selected subset of the General Ledger Matrix depicted in FIG. 14.

The Financial Data that would be supplied to external organizations such as financial analysis firms and banks is tracked as a selected subset of the Metrics Matrix depicted in FIG. 17.

Economic Data can be required as inputs into control models. Economic statistics such as consumer confidence index, stock price, new home sales, or inflation index can be obtained from data service providers. The format of this information must be compatible with the protocols supported by the Data Integration Layer services.

Tasks are the fundamental building blocks of all of the models. Process, project and business models are essentially groups of tasks.

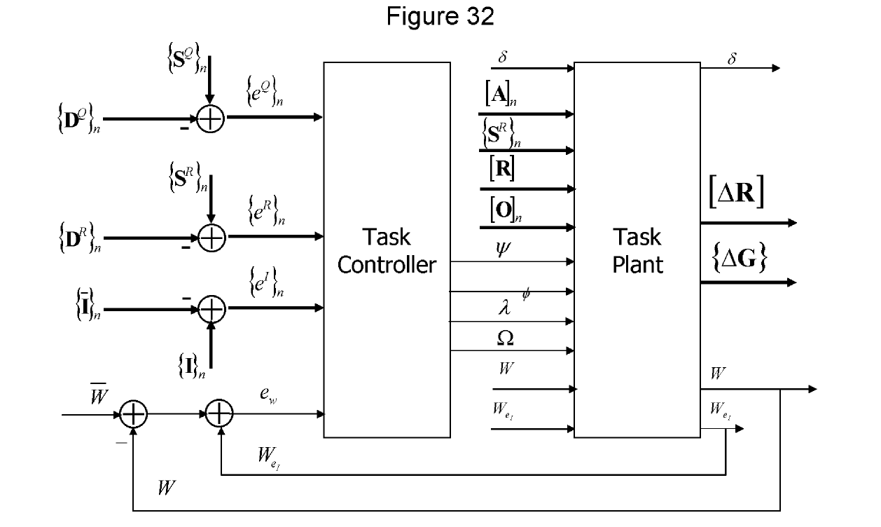

The generic task model is defined in FIG. 32. This model has two principle components—Plant Model, and Control Model.

The Task Model also includes several calculations to determine the variance between the benchmark task performance and the actual performance of the task. These calculations generate the values for the following parameters: Issue Variance, Resource Variance, and Work Variance. The Issue Variance is calculated as the difference between the Benchmark Issue Matrix and the pro-rated Actual Issue Matrix. The Resource Variance is calculated as the difference between the Input Demand Matrix and Input Supply Matrix. The Work Variance is calculated from the Benchmark Total Work, Actual Total Work, and Incremental Work Required.

The Task Plant Model consists of a set of transfer functions that convert the Plant Model input parameters to the Plant Model output parameters. The inputs to the Task Plant Model are the Resource Variation Control Signal, Issue Variation Control Signal, Work Variation Control Signal, Output Control Signal, Total Task Time, Total Work, Incremental Work Required, Input Supply Matrix, Resource Matrix, Accounting Matrix, and Output Matrix. The outputs to the Task Plant Model are Total Task Time, Actual Total Work, Incremental Work Required, General Ledger Changes, and Resource Changes. The Plant Model Transfer Functions generate the output values from the input values. The Total Task Time is calculated from the Total Task Time at the start of the Time Step and the duration of the Time Step whenever the Input Supply Matrix is not a null value. The Actual Total Work is calculated from the Actual Total Work at the start of the Time Step, Input Supply, and the Time Step. The Incremental Work Required is calculated from the Incremental Work at the beginning of the Time Step, the Input Supply, the Time Step, the Issue Variation Control Signal, and Resource Variation Control Signal. If there are more resources with the demanded skills supplied to the task, the task will generally complete more quickly. Conversely, the application of fewer resources than required will extend the duration of the task. If there are significantly less issues that modeled in the benchmark issue profile for the task, the task will take less time to complete. The General Ledger Changes are calculated from the Input Supply Matrix, Accounting Matrix, Resource Matrix, and Time Step. Resource Changes are calculated from the Output Matrix and Work Variation Control Signal. If the Work Variation Control Signal is greater than zero, the Resource Changes will be degraded as a function of this signal. The resulting Resource Changes will be compiled by the Resource Model to provide a comprehensive picture of the supply status for a given resource.

The Task Control Model consists of a set of transfer functions that convert the Task Control Model input parameters to the Task Control Model output parameters. The inputs to the Task Control Model are Issue Variance, Resource Quality Variance, Resource Quantity Variance, and Work Variance. The outputs to the Task Control Model are Issue Variation Control Signal, Resource Variation Control Signal, Work Variation Control Signal, and Output Control Signal. The Task Control Model Transfer Functions generate the output values from the input values. The Issue Variation Control Signal is calculated on the basis of a weighted difference between the benchmark issue profile for the task and the actual issue profile for the task. The Resource Variation Control Signal is calculated on the basis of the difference between the Input Demand Matrix and Input Supply Matrix. The Work Variation Control Signal is calculated on the basis of the Work Variance and Actual Total Work. The Output Control Signal is calculated on the basis of the Work Variance and is used to determine how the Output Matrix in FIG. 25 would be modified.

All deliverables produced or required by tasks are modeled as resources. In this context, a resource may represent a report or a commodity processed or produced by a given task. The fundamental characteristic of a resource is that it can be produced.

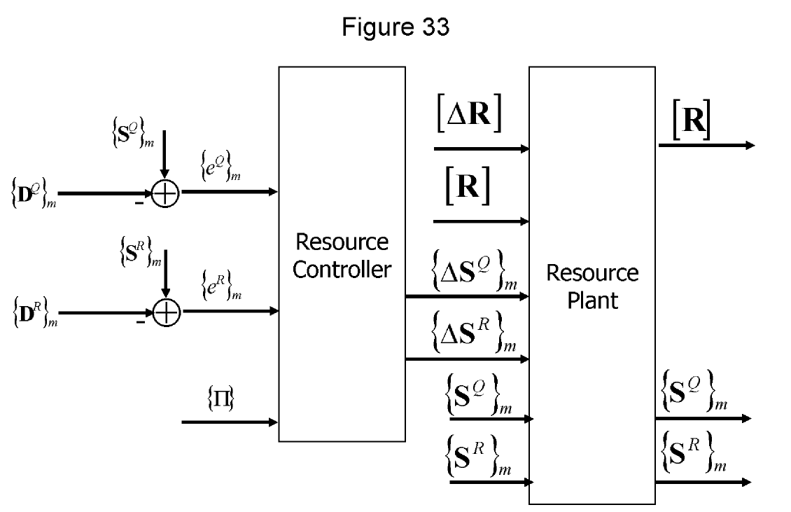

There must be at least one Resource Model that governs all resources required by the tasks in a given BCS domain. The generic resource model is defined in FIG. 33. Multiple instances of Resource Models can be instituted in a given BCS domain provided that there are no overlaps between the resources tracked in one model versus another model. There can only be one Resource Model owner for a given resource profile. Resource Models are typically associated with Business Models but could be associated with process or project Models if the resources required by the pertinent process or project are self-contained within the domain of the process or project of concern and the resource management responsibility for these resources lies within the pertinent process or project. The placement of Resource Models in a given Tree Structure should correlate to the node in the tree to which the resource management responsibility for a given set of resources has been allocated. For example, the manager of a functional organization is typically responsible for managing all of the resources corresponding to a given functional skill type. The Resource Model would then be allocated to node in the tree that corresponds to the functional manager node in the organization tree. The simplest approach to resource management would be to assign a single resource manager for all resources and leverage a single Resource Model for the entire BCS domain, but this could impair the management flexibility associated with being able to have different control models for different resource pools.

The Resource Model consists of two principle components—the Resource Plant Model and Resource Control Model. The Resource Model also includes calculations to determine the variance between the demand for resources and the supply of these resources to specific tasks. These calculations generate Resource Variance matrix used by the Resource Control Model.

The Resource Plant Model consists of a set of transfer functions that convert the Plant Model input parameters to the Plant Model output parameters. The inputs to the Resource Plant Model are the Input Supply Changes, Resources Changes, Resource Matrix, and Input Supply Matrix. The outputs to the Resource Plant Model are Resource Matrix and Input Supply Matrix. The Resource Plant Model Transfer Functions generate the output values from the input values. The Resource Matrix is calculated from the Resource Matrix at the beginning of the time step and the Resource Changes. The Input Supply Matrix is calculated from the Input Supply Matrix at the beginning of the time step and the Input Supply Changes.

The Resource Control Model consists of a set of transfer functions that convert the Plant Model input parameters to the Plant Model output parameters. The inputs to the Resource Control Model are the Resource Quality Variance, Resource Quantity Variance, and Task Rank Order Matrix. The output to the Resource Control Model is the Resource Quality Supply Change and Resource Quantity Supply Change. The Resource Control Model Transfer Function generates the output values from the input values. The Resource Supply Change Matrices are calculated from the Resource Variances and Task Rank Order Matrix. The Resource Control Model Transfer Function assumes that there is a finite availability for resources. The control model allocates resources to tasks in accordance with the rank order established by an analysis of the sensitivity of specific tasks to the performance objectives for a given BCS domain.

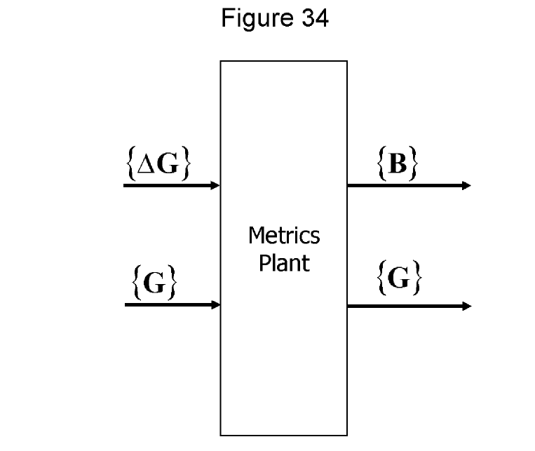

Metrics Models are transfer functions that take the General Ledger information and translate it to business performance metrics. The generic Metrics Model is depicted in FIG. 34. The translation between General Ledger and business performance metrics may take on different forms for different segments of a given organization. Instances of Metrics Models are created at each node in the tree structure that correlates to manager accountability for specific performance objectives. Typically, these instances occur wherever there is a business model or project model instance. It is assumed that General Ledger accounts are specific to the instance of the business model or project model. The inputs to the Metrics Model are the General Ledger Changes and General Ledger. The outputs of the Metrics Model are the Business Objectives and General Ledger. The General Ledger is calculated from the General Ledger at the beginning of the time step and the General Ledger Changes. The Business Objectives are calculated from the values in the General Ledger for the tree node of concern.

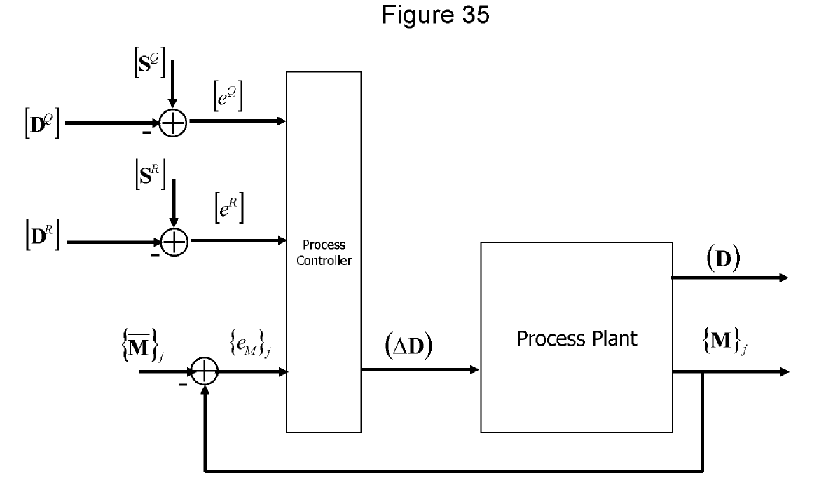

Processes are defined as a set of tasks that are executed in a cyclical manner for the purposes of a BCS. The generic process model is defined in FIG. 35. Once all of the tasks in a given process have been executed, the process begins once again with all cyclical task values such as cumulative work being reset. The sequence of tasks within a given process is defined by the input and output needs of the tasks which make up the process. Tasks that do not require any of the outputs of any of the other tasks within a given process can be executed at any time in the process life cycle whereas tasks which depend upon the existence of a specific resource must wait until that resource is available in order to step through the task.

A given process model may have multiple instances within a given organization. An example of where this might be the case is for a business' purchasing process. If each organization is responsible for ordering its own supplies on a periodic basis, it is generally advised that the same process be executed by each organization. Accounting would probably be responsible for defining the process model template, but each organization would create an instance of the process for execution by its own resources. A robust process library built in accordance with BCS guidelines will enable organizations to standardize processes and ensure that any improvements to a given process template can be directly leveraged by all organizations adhering to that template.

The Process Model consists of two principle components—Process Plant Model and Process Control Model. The Process Model also includes calculations to determine the Process Performance Variance and Resource Variance. The Process Performance Variance is calculated as the difference between the Benchmark Performance Metrics and Actual Performance Metrics. The Resource Variance is calculated as the difference between the Input Demand Matrix and Input Supply Matrix.

The Process Plant Model consists of a set of task model instances. The unique input to the Process Plant Model is the Input Demand Changes. The unique output to the Process Plant Model is the Metrics Matrix for the pertinent process node. The Process Plant Model Transfer Function is the superset of the task models associated with the Process Model node in the tree structure and the update of the Input Demand Matrix based upon the Input Demand Changes.

The Process Control Model consists of a set of transfer functions that convert the Process Control Model input parameters to the Process Control Model output parameters. The inputs to the Process Control Model are the Resource Quality Variance, Resource Quantity Variance, and Metrics Variance. The output to the Process Control Model is the Input Demand Changes. The Process Control Model Transfer Function generates the output values from the input values. The Input Demand Changes is calculated from Resource Variances and Metrics Variance. The Input Demand Changes matrix will adjust the Input Demand of tasks within the process model. This does not guarantee that the supply will be allocated to meet this adjusted demand.

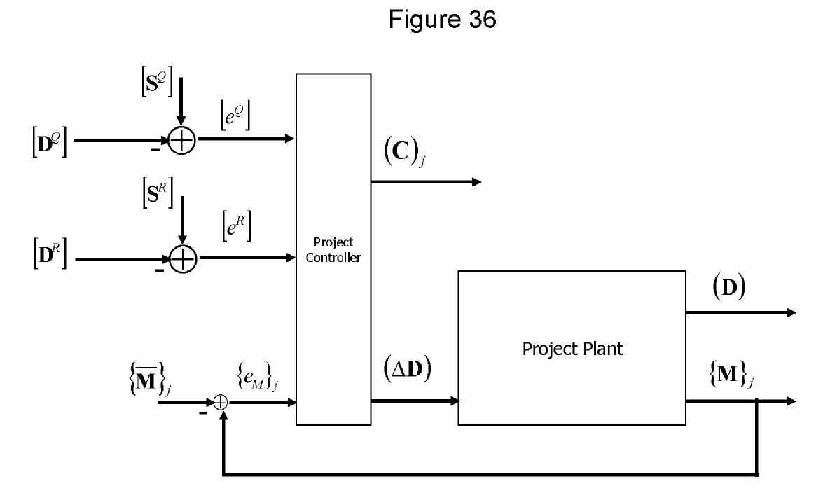

Projects share many of the same attributes of processes. They both consist of a control model and a plant model featuring a pre-defined group of tasks. The generic project model is defined in FIG. 36. Project life cycles can be captured in templates much as process templates can be generated. Unlike processes, projects are defined as one-time events for the purpose of the BCS. Projects are used to change the current operational state for processes and resource pools. If one views the control signals being applied at the individual task or resource model level as “micro” effectors, it would be appropriate to think of projects as “macro” effectors. Projects are the tangible agents of change that enable an organization to change the state of their business operations to achieve their business performance objectives. Examples of projects in this context are business process improvement projects, hiring a new resource, adding a new process to the business or migrating resources from one organization to another. A robust library of standard project models will provide Business Controllers with finer control capabilities when determining how to best meet the performance objectives for a given business unit.

Project models can be divided into two basic classes of projects—Development and Deployment. Development projects are one-time events that produce a given set of resources as outputs. Development projects do not change any active process instances, but they can change process model templates and the individual task benchmarks. Deployment projects do change active process instances for the organizations to which the product of the corresponding development project has been deployed. By differentiating between Development and Deployment projects, the BCS will have significantly more flexibility in determining the appropriate control signals to meet business performance objectives.

The Project Model consists of two principle components—Project Plant Model and Project Control Model. The Project Model also includes calculations to determine the Project Performance Variance and Resource Variance. The Project Performance Variance is calculated as the difference between the Benchmark Performance Metrics and Actual Performance Metrics. The Resource Variance is calculated as the difference between the Input Demand Matrix and Input Supply Matrix.

The Project Plant Model consists of a set of task model instances. The unique input to the Project Plant Model is the Input Demand Changes. The unique output to the Project Plant Model is the Metrics Matrix for the pertinent project node in the tree structure. The Project Plant Model Transfer Function is the superset of the task models associated with the Project Model node in the tree structure and the update of the Input Demand Matrix based upon the Input Demand Changes.

The Project Control Model consists of a set of transfer functions that convert the Project Control Model input parameters to the Project Control Model output parameters. The inputs to the Project Control Model are the Resource Quality Variance, Resource Quantity Variance and Metrics Variance. The outputs to the Project Control Model are the Input Demand Changes and Change Matrix. The Project Control Model Transfer Function generates the output values from the input values. The Input Demand Changes is calculated from Resource Variances and Metrics Variance. The Input Demand Changes matrix will adjust the Input Demand of tasks within the project model. This does not guarantee that the supply will be allocated to meet this adjusted demand. The Change Matrix is activated once the outputs of the project model tasks have been completed. The Change Matrix will be used to modify the benchmark values for active tasks and/or resources impacted by the products of the project.

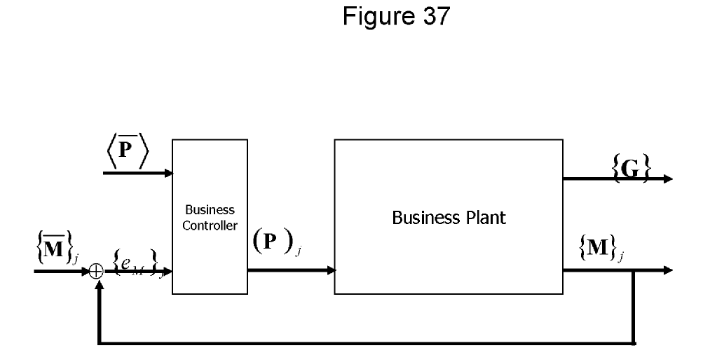

Business Models are groups of models pertaining to a given business, business unit or functional department. Business models consist of groups of project and process instances. Business models may also consist of groups of other business models. Business models are typically associated with one or more set of Metrics Models and Resource Models. The performance objectives associated with a given business unit are time-boxed and assumed to correlate to a standard performance monitoring period such as the Fiscal Year. A generic Business Model is depicted in FIG. 37.

The Business Model has two principle components—Business Plant Model and Business Control Model. It also features a calculation of the Metrics Variance on the basis of the difference between the benchmark business performance objectives and the actual performance objectives.

The Business Plant Model consists of a set process, project, resource and metrics model instances. The unique input to the Business Plant Model is the Project Matrix corresponding to one or more instances of projects designed to help the business change the current state of operations and meet the performance objectives for the business. The output of the Business Plant Model is Actual Performance Matrix associated with the Business Model node in the pertinent tree structure. The Business Plant Model Transfer Function is simply the superset of the process, project, resource and matrix models associated with the Business Model node in the tree structure. The Business Control Model consists of a set of transfer functions that convert the Business Control Model input parameters to the Business Control Model output parameters. The inputs to the Business Control Model are Benchmark Project Classes and Metrics Variance. The output to the Business Control Model is one or more Project Instances necessary to meet the performance objectives.

The Business Control Model Transfer Functions generate the output values from the input values. The selection or Project Instances is based upon the Metrics Variance and Benchmark Project Classes. New projects would not be initiated unless the Metrics Variance reaches a threshold that would justify the expense of the project that would be initiated to improve the business metrics.

Enterprise Models are groups of business models. Enterprise models can reflect subsidiaries of a single parent corporation, supply chains, partnerships between businesses or combinations thereof. The Enterprise model framework provides a consistent framework for the management of mergers or divestitures.

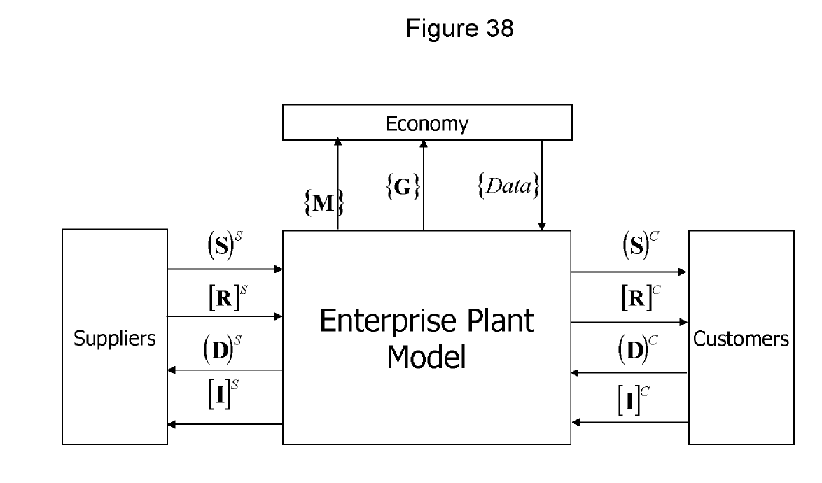

The Enterprise Model is depicted in FIG. 38. The Enterprise Model has four principle components—Enterprise Plant Model, Customer Model, Supplier Model, and Economy Model. While nothing precludes the inclusion of a control model for the Enterprise, a control model would typically not be applied to an Enterprise model due to the lack of any centralized control authority at the Enterprise level in this context. The business model construct would be more suitable when control elements are required. The Enterprise Plant Model consists of a set of business model instances. The unique inputs to the Enterprise Plant Model are the Customer Input Demand Matrix, Supplier Input Supply Matrix, Supplier Resource Matrix, and Economic Data. The outputs of the Enterprise Plant Model are the Supplier Input Demand Matrix, Customer Input Supply Matrix, Customer Resource Matrix, General Ledger (If public), and Performance Metrics (If public). The Enterprise Plant Model Transfer Function is simply the superset of the business models associated with the Enterprise Model. The inputs and outputs of the Enterprise Plant Model can be leveraged by the lower level models as necessary.

The Customer Model is not required for the BCS to function effectively. Customer Models can be generated and added to the BCS if desired, but only the data coming from the customer is really necessary. This data can typically be obtained by EDI or XML links to a customer data store.

The Supplier Model is not required for the BCS to function effectively. Supplier Models can be generated and added to the BCS if desired, but only the data coming from the supplier is really necessary. This data can typically be obtained by EDI or XML links to a supplier data store.

The Economy Model is not required for the BCS to function effectively. An Economy Model can be generated and added to the BCS if desired, but only the data coming from the Economic Data suppliers is really necessary and this data is only required if one of the BCS control models requires this information to execute effectively. This data can also typically be obtained by EDI or XML links to a customer data store.

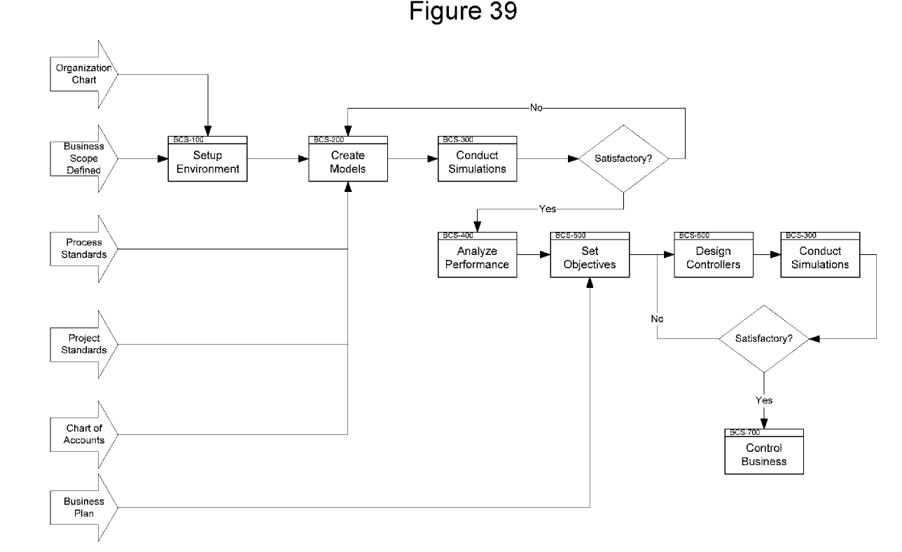

The BCS method is depicted in FIG. 39. Once the environment has been setup, the basic sequence of activities necessary to get a BCS operational is as follows: Create Models, Simulate Models, Analyze Models, Set Objectives, Design Controllers, and Control the business system.

Item BCS-100 in FIG. 39 refers to the Setup Environment task within the BCS business method. The process of setting up the Physical Environment features the definition of a Physical System Architecture in accordance with the BCS Logical Architecture defined in FIG. 1. The Physical Architecture consists of hardware, software and network connections. The Physical Architecture should be designed such that any system latencies are minimized as they could adversely affect the overall performance of the system or complicate the development of control models. Architects should leverage existing hardware and software systems that contain the information required to drive the BCS so long as the information is accessible by the Data Integration Services and does not contribute significant system latencies.

The User Interface Layer can be created as a separate suite of web browser compatible code, leverage the user interface of the applications in the application layer or feature combinations thereof so long as the resulting configuration is compatible with the requirements of the Logical Architecture.

The Application Layer can be configured to feature multiple applications or a single application so long as the applications are compatible with the requirements of the Logical Architecture.

The Data Layer can be configured to feature multiple databases across multiple servers so long as the administrator is able to access these sources and map the data within to the parameters required by the BCS.

Once all of the software has been installed on the hardware platforms identified in the Physical Architecture, the system administrator must configure the system via the Administrator UI module depicted in FIG. 9. The key features of this module are security management, application management, data source management, system metrics management, tree structure management, and environment management.

Item 191 in FIG. 9 provides the Administrator with the ability to manage application associations. The Administrator associates the applications with the pertinent user interface modules as defined in Section 101 of FIG. 2. Any API's required by each of these applications in order to access functionality contained within other enterprise applications should be identified and configured as required. The administrator is responsible for managing the versions of applications associated with a given system module and ensure that there are sufficient licenses to support the user community for a given application.

Item 192 in FIG. 9 provides the Administrator with the ability to manage data sources. The Administrator maps the core parameters required by the BCS to the data sources containing the values for these parameters. The data source mapping may be applied globally or to a specific node within a given tree structure for a given parameter so long as all parameters for all nodes of the tree are associated with a data source. The administrator is also responsible for identifying whether or not a given data source is read only or allows reading and writing of data to the data source from the BCS applications.

Item 193 in FIG. 9 provides the Administrator with the ability to manage tree structures. The Administrator creates the default tree structure corresponding to the initial scope of system deployment. The tree structure is developed in a hierarchal fashion started with a node for the Enterprise Model. The Enterprise Model is then decomposed into the pertinent business models. The organization chart for each business model is used to determine the organizations to be added to the tree structure. The processes for which each organization is responsible are added as children to the pertinent organization node. The active projects are also added as children to the organization responsible for the execution of the projects. These projects can be grouped into programs and sub-programs as warranted. Additional nodes are added for each instance of resource model required in the organization. The resulting tree structure will be used to guide the development and implementation of BCS models in subsequent steps.

Item 194 in FIG. 9 provides the Administrator with the ability to manage security profiles. The Administrator defines field-level security permissions for users and groups thereof. Security permissions can be provided globally or allocated only to specific nodes in a given tree structure.

Item 195 in FIG. 9 provides the Administrator with the ability to manage the Chart of Accounts. The Administrator creates the Chart of Accounts in the General Ledger Matrix based upon the structure used by the Accounting organization. The resulting tree structure will be used to guide the development and implementation of BCS metrics models.

Item 196 in FIG. 9 provides the Administrator with the ability to manage one or more instances of the BCS physical environment. Once the core system has been configured, the Administrator creates at least one additional virtual instance of the system environment. The Environment Management console is used by the Administrator to migrate models and data from one environment to another environment. This capability enables businesses to develop business control models or subsets thereof prior to rolling them to production. It also provides administrators with the ability to add business models from other organizations or split up existing business models for migration to another organization.

Item 197 in FIG. 9 provides the Administrator with the ability to manage the metrics associated with the system deployment. The Administrator defines the scope of the initial deployment via the system metrics management console. This console is used to track the operational readiness for each node of a given tree structure. System operation should not be initiated until all components of the initial deployment scope have been modeled, simulated, and analyzed as a minimum.

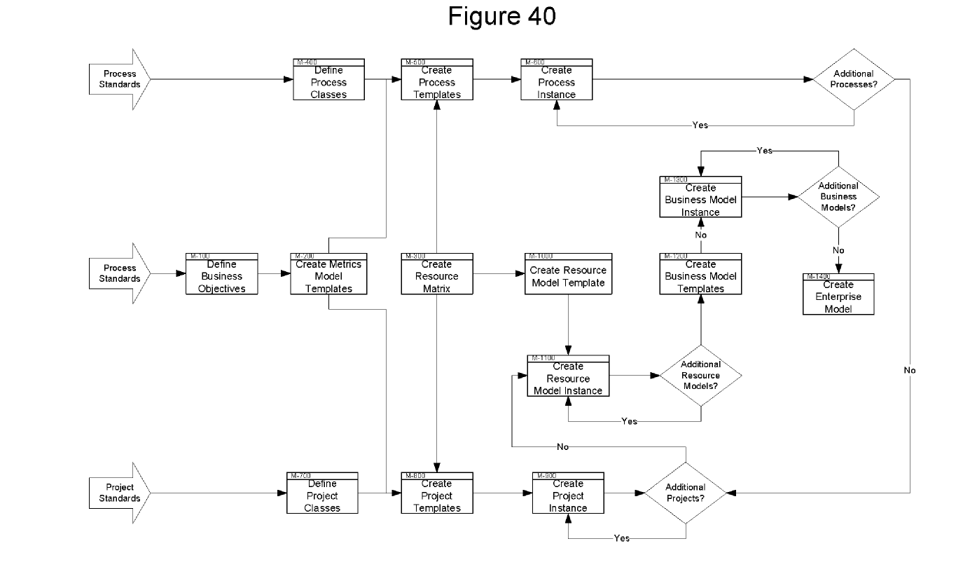

Item BCS-200 in FIG. 39 refers to the Create Models task within the BCS business method. The Create Model process is depicted in further detail in FIG. 40. The following models are configured using the model development application: task, metrics, resource, process, project, business, and enterprise.

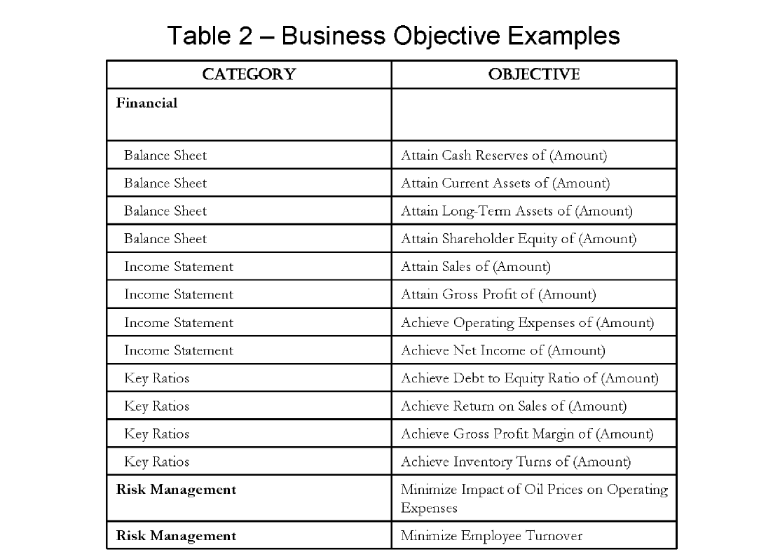

Item M-100 in FIG. 40 refers to the Define Business Objectives task within the BCS Create Model task. The business plan is used as a reference in determining the specific business objectives that need to be modeled in the system. Business objectives need to be specific and measurable. Sample business objectives are specified in FIG. 51.

Item M-200 in FIG. 40 refers to the Create Metrics Model task within the BCS Create Model task. The modeling application is used to generate transfer functions that will convert business objective targets to Performance Metrics used in the control of a given business or subset thereof.

The user selects one or more business objectives that are applicable to the template. These objectives will be used to populate the Business Objectives matrix for a given model.

The Business Objectives are converted to General Ledger objectives. The formulae for each business objective are captured in the Metrics model using General Ledger accounts as variables. The resulting matrix model is inverted so that General Ledger values can be calculated for a specific set of Business Objective targets.

The General Ledger targets are converted to Model Performance Metrics. The formulae for each performance metric (e.g. project cost, process cost, project duration) are captured in the Metrics Model using General Ledger accounts as variables. The resulting matrix model can be used to calculate Performance Metrics for a given set of General Ledger account values.

Item M-300 in FIG. 40 refers to the Create Resource Matrix task within the BCS Create Model task. The modeling application is used to generate a comprehensive list of resources and their respective attributes as defined in FIG. 26.

Item M-400 in FIG. 40 refers to the Define Process Classes task within the BCS Create Model task. A list of process classes is generated from the process standards for the organization.

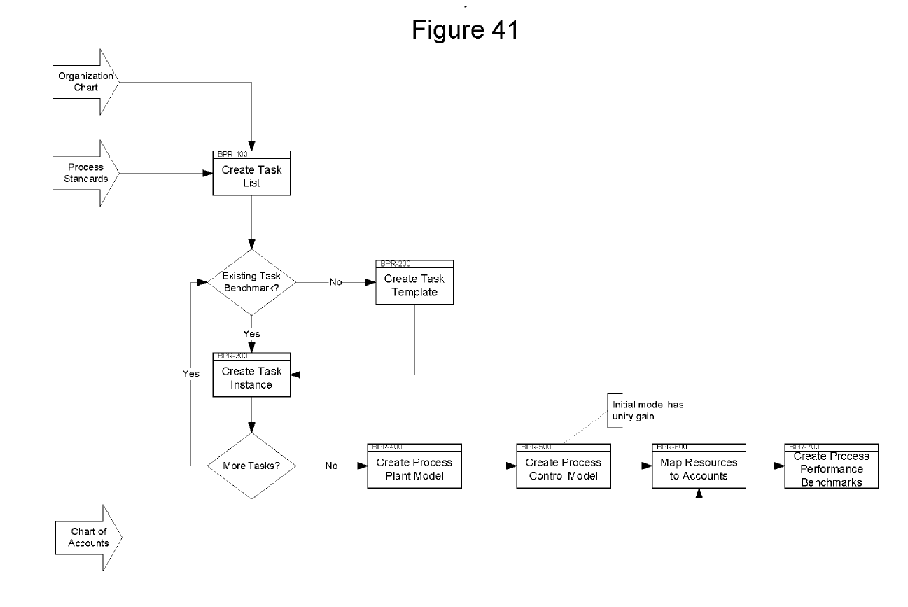

Item M-500 in FIG. 40 refers to the Create Process Templates task within the BCS Create Model task. This activity is described in more detail in FIG. 41. The modeling application is used to expedite model creation. These process model templates will provide benchmark data for actual process instances generated from these templates.

Item BPR-100 in FIG. 41 refers to the Create Task List task. The first step in the creation of a benchmark process is the generation of a list of tasks required to execute the process of concern. The task list includes a list of activities necessary to complete the process along with a list of inputs and outputs required by each of these activities as well as an estimate of the task duration.

Item BPR-200 in FIG. 41 refers to the Create Task Template task. If the task of concern has yet to be created in context of another process or in context of a project, a new task template is created. The creation of a task template does not mean that the task is active in the system. The task is only active in the system when an instance of the task has been incorporated into an active process or project model.

The first step in creating a task template is the creation of a task matrix. The parameters required in the task matrix are identified in FIG. 22. The benchmark task ID is not applicable to task templates as the task template is the benchmark task ID. The number of inputs and outputs is entered on the basis of the information captured in the task list. The benchmark task duration is entered based upon the information captured in the task list. The benchmark work is not entered as it will be automatically calculated via the formula resident in the task plant model.

The Input Demand Benchmark Matrix is defined by entering the number of units required for each input resource identified in the task list.

The Issue Benchmark Matrix is defined by entering the benchmark number of issues of each issue category associated with the duration assumption for the task. An example of issue categories would be “High”, “Medium” or “Low” impact issues.

The Output Matrix is generated on the basis of the benchmark resource, work and issue assumptions.

The task plant model is created by connecting the task plant model inputs and outputs identified in FIG. 32 to a plant model object in the modeling application. Formulae are entered for the calculation of each output variable as a function of the input variables.

The task control model is created by connecting the task control model inputs and outputs identified in FIG. 32 to a control model object in the modeling application. The task control model is updated to incorporate formulae and logical arguments pertaining to the calculation of control signal outputs. Control model features include the specification of relative weight factors for the impacts of each issue category and the establishment of the criterion for task completion (e.g. Work Variance=0).

Plant model outputs are connected to benchmark settings in the Task Matrix via comparators that generate variance values for the task control model.

Item BPR-300 in FIG. 41 refers to the Create Task Instance. An instance of the required task is created for the process model. The instance is assigned a unique task ID and maintains the link to the benchmark task ID by a parameter in the task matrix for the task instance.

Item BPR-400 in FIG. 41 refers to the Create Process Plant Model task. The Process Plant Model is created by connecting the inputs and outputs of the task instances compiled for the process.

Item BPR-500 in FIG. 41 refers to the Create Process Control Model task. The process control model is configured by establishing the performance conditions, if any, that would prompt the modification of the benchmark demand matrix for the tasks in the process. The conditions under which the process life cycle is reset are specified as well. The life cycle reset will reset the work and duration values in the Task Matrix.

The initial values of the control model parameters are established to so that the control model exerts no control effort (i.e. unity gain). The values of these parameters and the possible introduction of additional control logic will occur during the Controller Design activity.

Item BPR-600 in FIG. 41 refers to the Map Resources to Accounts task. In this task, the Accounting Matrix for each task is updated to identify the appropriate account for each resource in context of the process. A single resource may have its costs allocated to more than one cost account. The accrual of expenses or revenue for a given resource is a function of which task instance is consuming or producing the resource.

Item BPR-700 in FIG. 41 refers to the Create Process Performance Benchmarks task. A metrics model is added as an element of the Process Plant Model to enable monitoring and control of the overall process performance. The benchmark performance objectives for the process are calculated from the tasks that make up the process model. These objectives are stored in the Performance Matrix for the process.

Item M-600 in FIG. 40 refers to the Create Process Instances task within the BCS Create Model task. This task involves the creation of a specific instance of a process template in association with a pre-defined process node in the default tree structure. When a process instance is created, the process benchmark values are set by the pertinent process template and unique instances of each task within the process are created. The data sources for all tasks within the process need to be validated for each process instance.

Item M-700 in FIG. 40 refers to the Define Project Classes task within the BCS Create Model task. A list of project classes is generated from the project standards for the organization.

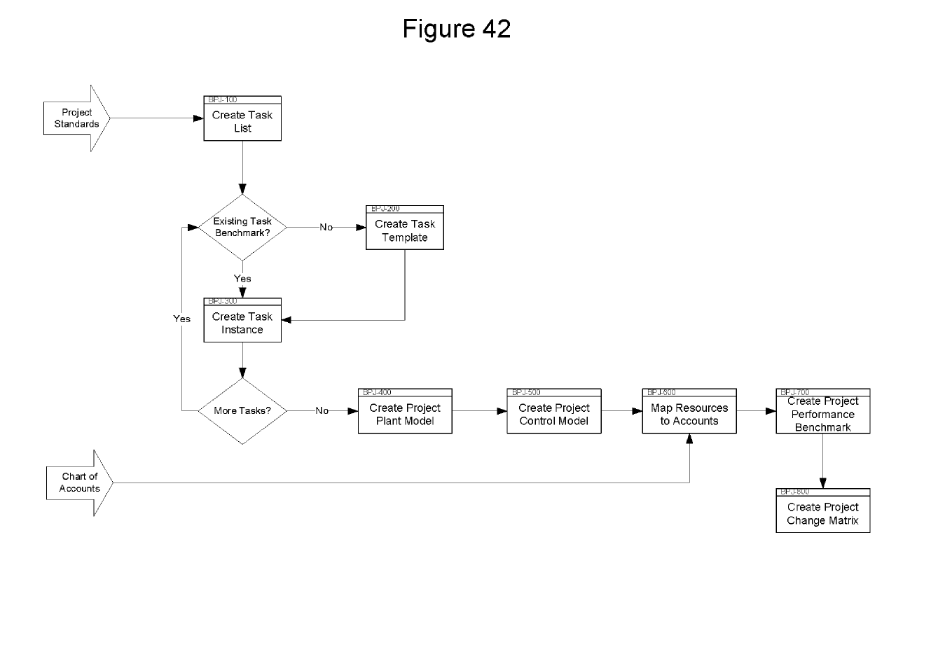

Item M-800 in FIG. 40 refers to the Create Project Templates task within the BCS Create Model task. This activity is described in more detail in FIG. 42. The modeling application is used to expedite model creation. These project model templates will provide benchmark data for actual project instances generated from these templates as well as serve as important inputs to business controllers.

Item BPJ-100 in FIG. 42 refers to the Create Task List task. The first step in the creation of a benchmark process is the generation of a list of tasks required to execute the process of concern. The task list includes a list of activities necessary to complete the process along with a list of inputs and outputs required by each of these activities as well as an estimate of the task duration.

Item BPJ-200 in FIG. 42 refers to the Create Task Template task. If the task of concern has yet to be created in context of another process or in context of a project, a new task template is created. The creation of a task template does not mean that the task is active in the system. The task is only active in the system when an instance of the task has been incorporated into an active process or project model.

The first step in creating a task template is the creation of a task matrix. The parameters required in the task matrix are identified in FIG. 22. The benchmark task ID is not applicable to task templates as the task template is the benchmark task ID. The number of inputs and outputs is entered on the basis of the information captured in the task list. The benchmark task duration is entered based upon the information captured in the task list. The benchmark work is not entered as it will be automatically calculated via the formula resident in the task plant model.

The Input Demand Benchmark Matrix is defined by entering the number of units required for each input resource identified in the task list.

The Issue Benchmark Matrix is defined by entering the benchmark number of issues of each issue category associated with the duration assumption for the task. An example of issue categories would be “High”, “Medium” or “Low” impact issues.

The Output Matrix is generated on the basis of the benchmark resource, work and issue assumptions.

The task plant model is created by connecting the task plant model inputs and outputs identified in FIG. 32 to a plant model object in the modeling application. Formulae are entered for the calculation of each output variable as a function of the input variables.

The task control model is created by connecting the task control model inputs and outputs identified in FIG. 32 to a control model object in the modeling application. The task control model is updated to incorporate formulae and logical arguments pertaining to the calculation of control signal outputs. Control model features include the specification of relative weight factors for the impacts of each issue category and the establishment of the criterion for task completion (e.g. Work Variance=0).

Plant model outputs are connected to benchmark settings in the Task Matrix via comparators that generate variance values for the task control model.

Item BPJ-300 in FIG. 42 refers to the Create Task Instance. An instance of the required task is created for the project model. The instance is assigned a unique task ID and maintains the link to the benchmark task ID by a parameter in the task matrix for the task instance.

Item BPJ-400 in FIG. 42 refers to the Create Project Plant Model task. The Project Plant Model is created by connecting the inputs and outputs of the task instances compiled for the project.

Item BPJ-500 in FIG. 42 refers to the Create Project Control Model task. The project control model is configured by establishing a parametric model for the performance conditions, if any, that would prompt the modification of the benchmark demand matrix for the tasks in the project. The conditions under which the project is completed are specified as well. Once the project is completed, the project control model will activate the Change Matrix. The Change Matrix will update the benchmark values of task matrices, input demand matrices, issue matrices and resource matrices for the tasks and/or resources affected once the project objectives have been achieved.

The initial values of the control model parameters are established so that the control model exerts no control effort (i.e. unity gain). The values of these parameters and the possible introduction of additional control logic will occur during the Controller Design activity.

Item BPJ-600 in FIG. 42 refers to the Map Resources to Accounts task. In this task, the Accounting Matrix for each task is updated to identify the appropriate account for each resource in context of the project. A single resource may have its costs allocated to more than one cost account. The accrual of expenses or revenue for a given resource is a function of which task instance is consuming or producing the resource.

Item BPJ-700 in FIG. 42 refers to the Create Project Performance Benchmarks task. A metrics model is added as an element of the Project Plant Model to enable monitoring and control of the overall project performance.

The benchmark performance objectives for the project are calculated from the tasks that make up the project model. These objectives are stored in the Performance Matrix for the project.

Item BPJ-800 in FIG. 42 refers to the Create Project Change Matrix task. The Project Change Matrix contains projected metrics improvements, changes to the resource matrix, changes to task benchmark matrices, the input demand benchmark matrix, and issue benchmark matrix. The projected metrics improvements are calculated from the changes to the resource matrix, task benchmark matrices, input demand benchmark matrix and issue benchmark matrix and the number of active tasks that would be impacted by these changes. The projected metrics improvements can be automatically scaled as the number of tasks affected by the change matrix is increased or decreased. The changes to the resource matrix are fairly straightforward. If the project is “Hire New Employee”, the change to the resource matrix would be the addition of a new employee profile to the resource matrix and the assignment of the employee to one or more tasks within the business. The changes to the task benchmark matrix can be calculated on the basis of changes to the input demand matrix for work values or simply change the projected task duration for a few tasks. Changes to the Input Demand Matrix would be applied based upon estimates from subject matter experts. If a task is to be automated, for example, the demand for administrative personnel may decrease while the demand for technical support personnel may increase somewhat. The changes to the issue benchmark matrix would be updated on the basis of inputs from subject matter experts as well.

Item M-900 in FIG. 40 refers to the Create Project Instances task within the BCS Create Model task. This task involves the creation of a specific instance of a project template in association with a pre-defined project node in the default tree structure. When a project instance is created, the project benchmark values are set by the pertinent project template and unique instances of each task within the project are created. The data sources for all tasks within the project need to be validated for each project instance.

Item M-1000 in FIG. 40 refers to the Create Resource Model Template task within the BCS Create Model task. The modeling application is used to create a Resource Model Template. Instances of this template will be distributed throughout the organization to reconcile resource supply and demand as well as manage changes to the resource matrix. The Resource Model features two primary components—The Resource Plant Model and the Resource Control Model.

The Resource Plant Model features formulae that change the state of the Resource Matrix and Supply Matrix for a given segment of the overall resource pool for the enterprise.

The Resource Control Model is created by establishing a parametric model for the performance conditions, if any, that would prompt the modification of the supply matrix for the resources managed by a given resource model. This parametric model is intended to leverage data from sensitivity data calculated during the analysis stage. The sensitivity matrix will provide information necessary to prioritize tasks in a manner that will maximize the ability of the organization to meet specific performance objectives. Tasks that have the most positive influence on performance objectives will be prioritized ahead of tasks that have little influence on the achievement of performance objectives.

The initial values of the control model parameters are established so that the control model exerts no control effort (i.e. unity gain). The values of these parameters and the possible introduction of additional control logic will occur during the Controller Design activity.

Item M-1100 in FIG. 40 refers to the Create Resource Model Instance task within the BCS Create Model task. This task involves the creation of a specific instance of the Resource Model template in association with a pre-defined resource model node in the default tree structure. The ownership parameter in the resource matrix for each resource governed by the resource model instance is updated to reflect this ownership status. The data sources for all parameters within the resource model need to be validated for each resource model instance.

Item M-1200 in FIG. 40 refers to the Create Business Model Template task within the BCS Create Model task. Business Model Templates can be generated for functional organizations or replicated business unit segments. For example, the sales organization may be distributed into multiple regions across the globe. If the basic processes within the sales organization do not vary significantly from region to region, it might be worthwhile to generate a business template to expedite the creation of business model instances and maximize commonality across regions in order to increase the impact of process improvements. The concept of business model templates is especially useful in the management of franchise business models.

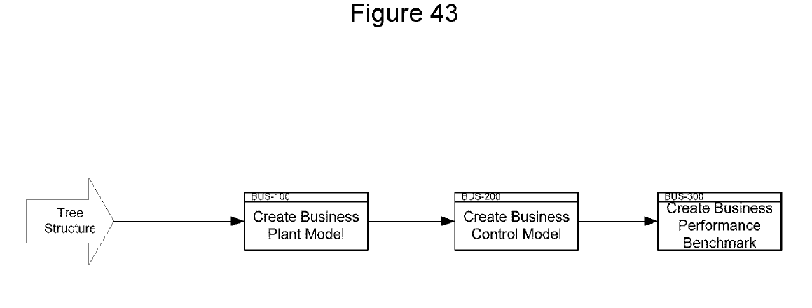

Item BUS-100 in FIG. 43 refers to the Create Business Plant Model task. The Business Plant Model is created by connecting the inputs and outputs of the task instances compiled for the project.

Item BUS-200 in FIG. 43 refers to the Create Business Control Model task. Projects are the control signals for business models. The business control model is configured by establishing a parametric model for the performance conditions, if any, that would prompt the creation, modification or deletion of a project instance. This parametric model will compare project class benchmark data with the performance variance of the business model. If the performance variance reaches a given threshold, a project instance will be created to ensure that the business plant model performance is adjusted to achieve the desired performance objectives. Project class performance metrics at the task-level and project-level can be scaled in proportion to any differences that may exist between the necessary performance changes and the default performance changes for a given project class.

The initial values of the control model parameters are established to so that the control model exerts no control effort (i.e. unity gain). The values of these parameters and the possible introduction of additional control logic will occur during the Controller Design activity.

Item BUS-300 in FIG. 43 refers to the Create Business Performance Benchmarks task. A metrics model is added as an element of the Business Plant Model to enable monitoring and control of the overall business performance.

The benchmark performance objectives for the business are calculated as a sum of the benchmark performance objectives for the processes and projects governed by the business. These objectives are stored in the Performance Matrix for the business.

Item M-1300 in FIG. 40 refers to the Create Business Model Instance task within the BCS Create Model task. An instance of a business model template will be generated for each management position in accordance with the default tree structure. The data sources for all tasks within the business need to be validated for each business instance.

Item M-1400 in FIG. 40 refers to the Create Enterprise Model task within the BCS Create Model task. The Enterprise Model represents the superset of all business activities for a given enterprise. The Enterprise Model is used to manage the interaction between the a given enterprise and the outside world including customers, suppliers and market conditions.

Each customer is modeled by a single task model if the business model for the customer is not available. If a customer business model is available, it can be used in place of the single task model construct. Assuming that the single task model construct is used, the creation of a customer model features the same tasks identified BPR-200. Revenue associated with sales of goods or services to customers would be tracked in context of changes to the general ledger as calculated by the task plant model. The data sources for all information in the task model needs to be validated for each customer instance.

Each supplier is modeled by a single task model if the business model for the supplier is not available. If a supplier business model is available, it can be used in place of the single task model construct. Assuming that the single task model construct is used, the creation of a supplier model features the same tasks identified BPR-200. Expenses associated with receipt of goods or services from suppliers would be tracked in context of changes to the general ledger as calculated by the task plant model. The data sources for all information in the task model needs to be validated for each supplier instance.

A Market Model is an optional element of the Business Control System. An Enterprise Model could be generated to model all businesses within a given industry vertical. The default representation of a Market Model, however, is simply the connection of data sources that might be needed to effectively implement one or more control models within the system. The data sources for all information in the task model needs to be validated for each market data set.

Item BCS-300 in FIG. 39 refers to the Conduct Simulations task within the BCS business method. This task can be executed any time after the models have been developed but appears twice in the basic BCS method sequence—once after the base models have been built and once after a new or redesigned controller has been modeled. The Simulation Stage uses the Simulation Application to evaluate the models for accuracy and generate forecasts of future performance. Simulations can be conducted for any branch of the tree structure.

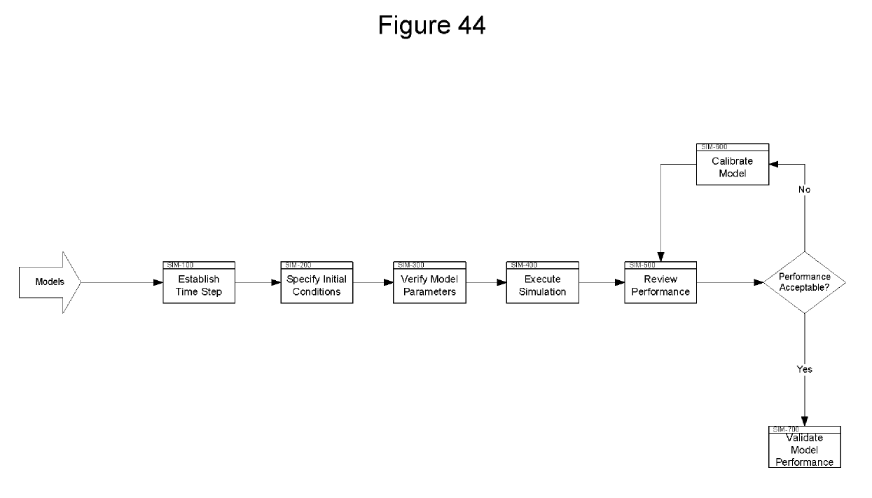

Item SIM-100 in FIG. 44 refers to the Establish Time Step task. The simulation time step drives the number of model calculation iterations that will occur within a given computational cycle as constrained by the physical architecture. Once the dominant time constants for the system are known from the results of system analyses, the time steps can be specified in a manner that ensures that the dominant system characteristics will be evident from the simulation.

Item SIM-200 in FIG. 44 refers to the Specify Initial Conditions task. The initial values of all input parameters for the BCS model need to be specified prior to simulating the model performance. Users will have the option of taking a snapshot of the input values in the current production environment or assign values individually to each parameter.

Item SIM-300 in FIG. 44 refers to the Verify Model Parameters task. The values of parameters inside the plant and control models are verified to ensure that they reflect the desired values.

Item SIM-400 in FIG. 44 refers to the Establish Time Step task. The system is stepped through time in accordance with the discrete time simulation engine of the Simulation Application.

Item SIM-500 in FIG. 44 refers to the Establish Time Step task. The performance metrics of the system or subset thereof are evaluated against expected results.

Item SIM-600 in FIG. 44 refers to the Establish Time Step task. The model parameters and/or input parameters are adjusted to align model performance with expected results.

Item SIM-700 in FIG. 44 refers to the Validate Model Performance task. Once the model or set thereof has performed in accordance with expectations, the model is considered “Validated”. Validated models can be rolled to the production environment.

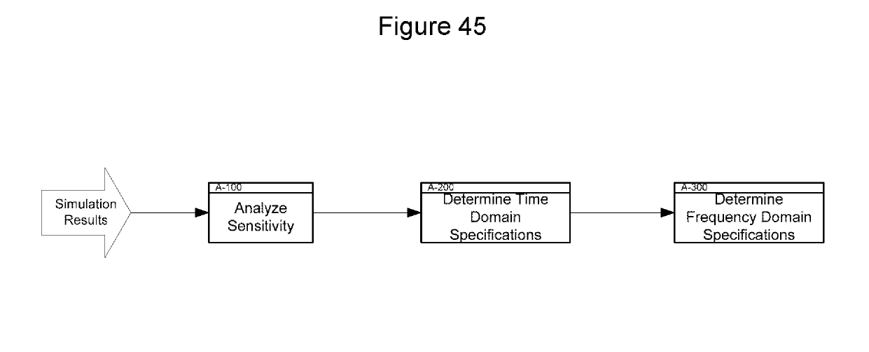

Item BCS-400 in FIG. 39 refers to the Analyze Performance task within the BCS business method. This activity is described in more detail in FIG. 45. The Analysis Stage uses the Analysis Application to determine the Sensitivity, Steady State Performance, Frequency Domain and Time Domain Specifications for the business system or subset thereof.

Item A-100 in FIG. 45 refers to the Analyze Sensitivity task. The sensitivity of each performance objective to tasks within the active branch of the tree structure is calculated through the application of numerical methods pertaining to partial differentiation. The result of this analysis is the Sensitivity Matrix. This sensitivity matrix is converted into a rank order matrix of tasks that can be used to prioritize resource allocation in Resource Controllers.

Item A-200 in FIG. 45 refers to the Determine Time Domain Specifications task. The analysis application is used to determine the time domain specifications for the active branch of the tree structure. These specifications are determined for each of the output parameters for the model of interest or set thereof using the current parametric values for the model.

The steady state error is calculated as the difference between the model input and output when subject to a unit step function.

The overshoot is calculated as the maximum difference between the transient and steady-state solutions for a unit-step function input.

The delay time is calculated as the time required for the response to a unit-step function input to reach 50 percent of its final value.

The rise time is calculated as the time required for the response to a unit-step function input to rise from 10 to 90 percent of its final value.

The settling time is calculated as the time required for the response to a unit-step function input to reach and remain within a specified percentage of its final value.

Time domain specifications for a variable gain can be evaluated by reviewing a plot of the poles and zeroes for the closed-loop transfer function of the model branch of concern.

Item A-300 in FIG. 45 refers to the Determine Frequency Domain Specifications task. The analysis application is used to determine the frequency domain specifications for the active branch of the tree structure. These specifications are determined for each of the output parameters for the model of interest or set thereof using the current parametric values for the model.

The Gain Margin is calculated as the magnitude of the reciprocal of the open-loop transfer function evaluated at the phase crossover frequency (i.e. phase =−180 degrees).

The Phase Margin is calculated as the 180 degrees plus the phase angle of the open-loop transfer function at unity gain.

The Delay Time calculation is depicted in FIG. 45.

The Bandwidth is defined as the range of frequency over which the system will satisfy performance specifications.

The Cutoff Rate is calculated as the frequency rate at which the magnitude ratio decreases beyond the cutoff frequency (max or min frequency associated with pertinent Bandwidth values).

The Resonance Peak is the maximum value of the magnitude of the closed-loop frequency response.

The Resonant Frequency is the frequency at which the Resonance Peak occurs.

Gain and Phase Margins are measures of the relative stability of the system. The larger the margins, the more stable the performance of the business. These values provide tangible measures of a company's stability. Gain Margins can be evaluated by a plot of gain versus frequency. Phase Margins can be evaluated by a plot of phase versus frequency.

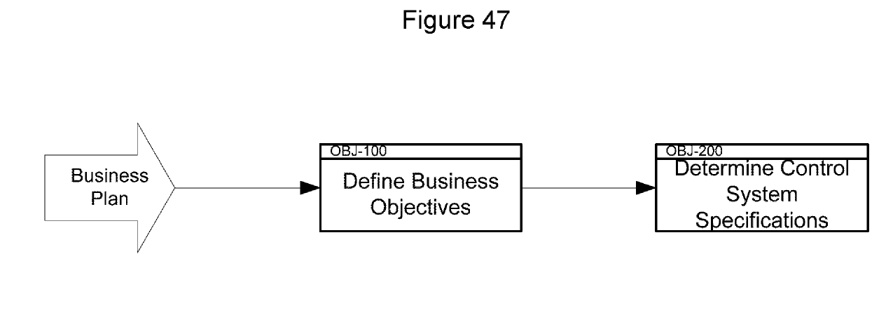

Item BCS-500 in FIG. 39 refers to the Set Objectives task within the BCS business method. This activity is described in more detail in FIG. 47. The Objectives Stage features the use of the Objectives Application to convert user business objectives into performance specifications that can be used to design controllers that achieve these objectives.

Item OBJ-100 in FIG. 47 refers to the Define Business Objectives. Business Objective targets are established for each active metrics model in the system.

Item OBJ-200 in FIG. 47 refers to the Determine Control Systems Specifications task. The Objectives Application automatically calculates the performance specifications for each Metrics Model. The resulting performance specifications are stored in the performance matrix for the pertinent model.

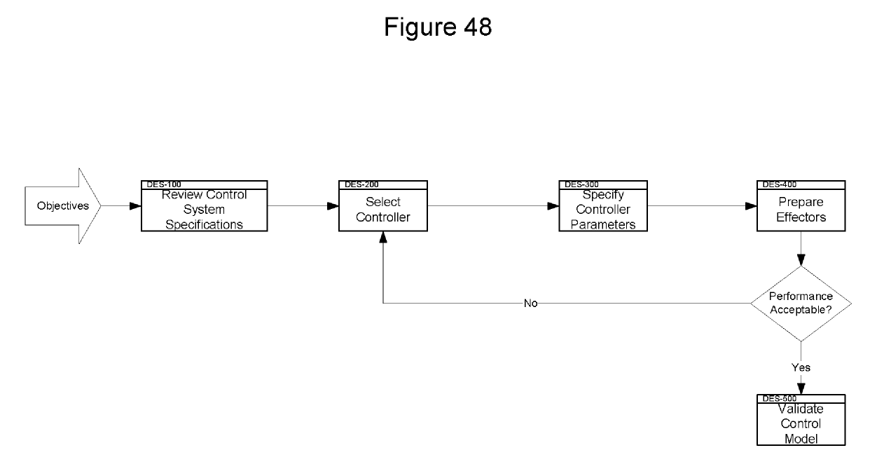

Item BCS-600 in FIG. 39 refers to the Design Controllers task within the BCS business method. This activity is described in more detail in FIG. 48. Using analysis techniques similar to those used in the Analysis Stage, the Design Application is used to design control models to meet the performance objectives associated with a given model.

Item DES-100 in FIG. 48 refers to the Review Performance Specifications task. The Design User Interface is populated with the current performance specifications for the active model side-by-side with the desired performance specifications. The user also has the ability to review the current time and frequency domain plots pertinent to the active model.

The base performance specifications are typically focused on steady-state values for a given set of output parameters. The user now has the opportunity to associate more detail specifications around each specification that could be used in association with the plots to design a more effective system. Examples of detail specifications that might not have been explicitly identified in the business objectives might be maximum overshoot or rise time.

Item DES-200 in FIG. 48 refers to the Select Controller task. If the current performance specifications do not satisfy the performance objectives, the user is able to edit the configuration of the existing control model. The current control model can be replaced by a variety of controller types:

Gain Factor Compensation

Lead Compensation

Lag Compensation

Lead-Lag Compensation

Cancellation Compensation

The control model is updated to reflect the selected controller class, but one or more of the control model parameters may yet be undefined.

Item DES-300 in FIG. 48 refers to the Specify Control Parameters task. The values of the control model parameters can be determined by examination of the time or frequency domain plots. General control systems design rules of thumb or simple trial and error can be leveraged to identify the appropriate parametric values from these plots. Once parameters have been specified, the plots will be updated to reflect the values entered. Once the performance of the model is acceptable, the control model is saved.

Item DES-400 in FIG. 48 refers to the Prepare Effectors task. Each control model needs one or more “effectors” to modify the state of current operations in some manner. These effectors may take various forms. If the controller governs a manufacturing process, the control model may be directly linked to actuators controlling machinery. If the controller governs people, the effectors need to take a different form. In these cases, computerized messages can be used to direct one or more resources to take a specific course of action such as “change assignments”. These messages can be automated by creating message templates in Enterprise Collaboration Systems. These templates would have fields associated with pertinent model parameters such as the task ID for a new assignment. It is important to ensure that all of the control signals for the controller have an effective mechanism to communicate these commands to a pertinent effector.

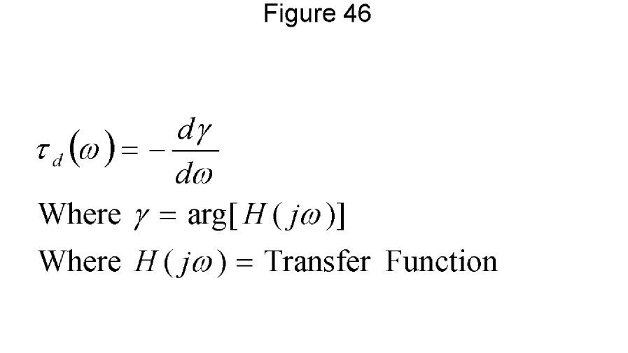

Item DES-500 in FIG. 46 refers to the Validate Control Model task. Once the model of concern has been analyzed to confirm that it meets performance specifications and that all of its control signals have valid effectors, the control model is considered “Validated”. Validated models can be rolled to the production environment.

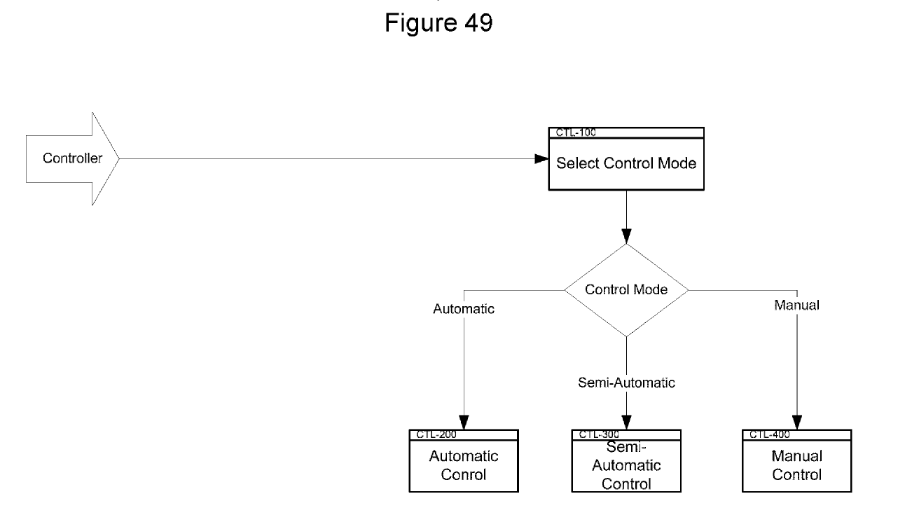

Item BCS-700 in FIG. 39 depicts the Control Business task. This activity is described in more detail in FIG. 49. The Control Business activity features the execution of business operations in accordance with the business control system models.

Item CTL-100 in FIG. 49 refers to the Select Control Mode task. The BCS offers three unique control modes—Automatic, Semi-Automatic, and Manual. The control mode for each controller is selected on the basis of the following criteria:

Speed of response required

Business risk

Employee sensitivity

Model maturity

For example, automatic control should be reserved for applications in which time response is critical and there is little risk of employee sensitivity. Semi-automatic control should be used when time response is critical and there is significant risk of employee sensitivity. Manual controls should be used in all cases when the model has not been in production for a significant amount of time.

Item CTL-200 in FIG. 49 refers to Automatic Control. Automatic Control features the execution of controller commands without a human in the loop.

Item CTL-300 in FIG. 49 refers to Semi-Automatic Control. Semi-Automatic Control features the generation of control signal commands, but the commands are not issued to effectors until a human has reviewed and authorized the commands.

Item CTL-400 in FIG. 49 refers to Manual Control. Manual Control features a human reviewing system performance data on a regular basis and issuing control signals based upon the analytical data provided in the system.

References used in the preparation of this specification are as follows:
(1) Aneirin Sion Owen, Accounting for Business Studies, Oxford, Elsevier Butterworth-Heinemann 2003
(2) Di Stefano III, Stubberud, Williams, Schaum's Outline of Theory and Problems of Feedback and Control Systems, New York; McGraw-Hill, Inc. 1967.
(3) William J. Palm III, Control Systems Engineering, New York; John Wiley& Sons, Inc. 1986

What is claimed is:

1. A method of designing control models for business activities such as processes, projects, businesses or sets thereof to meet quantitative financial performance objectives that features:
An association of the business activity scope with a specific node on a hierarchal tree;
A plant model corresponding to the scope of business activity for the controller;
Simulation of the plant model using discrete time step simulation tools;
Analysis of the plant model using s-domain, z-domain, or frequency domain control system analysis techniques to determine system specifications;
Establishment of financial performance objectives derived from account information stored in a company's general ledger;
Translation of financial performance objectives to system specifications
Comparison of objectives-based system specifications to the results of the model analysis to determine the most appropriate control model design to meet the financial performance objectives;
Establishment of the parametric values for the control model using s-domain, z-domain, or frequency domain control system design techniques.

2. A method of applying the control models cited in claim 1 to execute management functions governing resource allocation and project selection so as to meet specific financial performance objectives in an automated manner.

3. A method of developing one or more task models to support claim 1 or claim 2 that features: a control model that converts resource quantity variances, resource quality variances, issue profile variances, and work variances into control signals pertaining to resource variation, issue variation, and work variation that are used by the plant model; a plant model that converts control signals pertaining to resource variation, issue variation, and work variation into updated values for intrinsic task properties such as work completed, incremental work required due to control signals, resources produced or consumed, and incremental financial values for general ledger accounts; meta data specific to the overall task model including references to benchmark task model data, number of inputs, number of outputs, cumulative work, and cumulative task duration.

4. A method of developing one or process models to support claim 1 or claim 2 that features: a control model that converts resource quantity variances, resource quality variances and performance metrics variances into control signals responsible for changing the demand for resources assigned to tasks within the process; a plant model that updates process metrics on the basis of task metric updates and updates resource demands for its constituent tasks on the basis of changes to this demand prompted by the process control model; meta data specific to the overall process model including performance metrics for the process.

5. A method of developing one or more project models to support claim 1 or claim 2 that features: a control model that converts resource quantity variances, resource quality variances, and performance metrics variances into control signals responsible for changing the demand for resources assigned to tasks within the project and for initiating changes to the operational states for current tasks on the basis of project execution; a plant model that updates the project metrics on the basis of task metric updates and updates resources demands for its constituent tasks on the basis of changes to this demand prompted by the project control model; meta data specific to the overall project model including performance metrics for the project and projections for operational state changes that will result from the successful completion of the project.

6. A method of developing one or more business models to support claim 1 or claim 2 that features: a control model that automatically determines if a new project is necessary to minimize the variance between current and desired performance metrics, selects the appropriate project class, and scales the benchmark project for that class as required to create a project instance that will enable the business to close the gap; a plant model that updates the performance metrics and general ledger account values for the business on the basis of the outputs from its constituent tasks; meta data specific to the overall business model including performance metrics for the business.

7. A method of developing an enterprise model to support claim 1 or claim 2 that features: a supplier model that identifies the resources supplied by a given supplier as well as the attributes of these resources, identifies the resources required by the supplier, and tracks an issue profile pertaining to the supplier; a customer model that identifies the resources required by a given customer, identifies the resources supplied to the customer along with their attributes, and tracks an issue profile pertaining to the customer; an economy model that generates performance metrics and general ledger information for export to regulatory bodies in support of financial reporting requirements and identifies market data that may be required to support the development and execution of control models within the enterprise.

8. A method of developing one or more resource models to support claims 1 through 7 that features: a control model that converts resource quantity variance, resource quality variances, and data pertaining to the sensitivity of individual business objectives to specific tasks into changes in the allocation of resources to tasks; a plant model that updates the allocation of resources to specific tasks on the basis control model changes and updates resource profiles on the basis of task completions.

9. The use of the models defined in claims 3 through 8 to serve as the basis of an analysis to determine the robustness of the financial stability of a proposed or existing business in terms of performance margins associated with specific financial performance objectives.

10. A method of generating controller performance specifications from business performance objectives featuring: the translation of business performance objectives to general ledger account values, the translation of general ledger account values to activity-specific performance metrics, and the translation of activity-specific performance metrics to controller performance specifications.
